(19) United States
(12) Patent Application Publication
(10) Pub. No.: US 2025/0335067 A1
(43) Pub. Date: Oct. 30, 2025

(54) Devices, Methods, and Graphical User Interfaces for Providing Controls for a Browser Application

(71) Applicant: Apple Inc., Cupertino, CA (US)

(72) Inventors: Charles D. Deets, San Jose, CA (US); Marco Triverio, San Francisco, CA (US)

(21) Appl. No.: 19/190,473

(22) Filed: Apr. 25, 2025

Related U.S. Application Data
(60) Provisional application No. 63/640,830, filed on Apr. 30, 2024.
(60) Provisional application No. 63/657,014, filed on Jun. 6, 2024.

(51) Int. Cl. G06F 3/0482; G06F 9/451

(52) U.S. Cl. CPC G06F 3/0482; G06F 9/451

(57) ABSTRACT

A computer system displays a first user interface for a web browser application that includes a user-selectable option and detects a user input selecting the user-selectable option. The computer system, in response to detecting the user input: in accordance with a determination that content of the first user interface is not associated with related content, displays a first menu for the web browser application that includes a first plurality of options for interacting with the web browser application. The computer system, in accordance with a determination that content of the first user interface is associated with related content, displays a second menu for the web browser application that includes concurrent display of: a second plurality of options for interacting with the web browser application; and a first user interface element for a first type of related content that is related to the content of the first user interface.

### RELATED APPLICATIONS

This application claims priority to U.S. Provisional Patent Application No. 63/657,014, filed Jun. 6, 2024, and U.S. Provisional Patent Application No. 63/640,830, filed Apr. 30, 2024, each of which is hereby incorporated by reference in its entirety.

### TECHNICAL FIELD

This relates generally to electronic devices with a browser application on a computer system that is in communication with one or more input devices.

### BACKGROUND

Users are able to navigate to various web content using one or more web browsers. Some browsers provide additional functionality and/or controls that improve the user experience, such as through the use of plugins and/or extensions. It can be difficult for a user to navigate the settings of web browsers, which are often hidden behind complex menu hierarchies.

### SUMMARY

Accordingly, there is a need for electronic devices with faster, more efficient methods and interfaces for interacting with control options for a browser application, including providing intelligent content in a browser application. Such methods and interfaces optionally complement or replace conventional methods for interacting with a browser application (e.g., also referred to herein as a web browser). Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display and one or more input device. The method includes displaying, on the display, a first user interface for a web browser application that includes a user-selectable option. The method includes detecting a user input, via the one or more input devices, selecting the user-selectable option displayed in the first user interface; and in response to detecting the user input: in accordance with a determination that content of the first user interface is not associated with related content, displaying a first menu for the web browser application that includes a first plurality of options for interacting with the web browser application. The method includes, in accordance with a determination that content of the first user interface is associated with related content, displaying a second menu for the web browser application that includes concurrent display of: a second plurality of options for interacting with the web browser application; and a first user interface element for a first type of related content that is related to the content of the first user interface.

In accordance with some embodiments, a method is performed at a computer system that is in communication with a display and one or more input devices. The method includes displaying, on the display, a first user interface for a web browser application. The method includes, in accordance with a determination that the first user interface includes video content: displaying a user interface element for expanding the video content in the first user interface. The method includes detecting a first user input selecting the user interface element for expanding the video content in the first user interface; and in response to detecting the first user input, updating the first user interface, including: increasing a size of the video content to an expanded size; and ceasing display of at least a portion of the first user interface. The method includes, in accordance with a determination that the first user interface does not include video content, forgoing display of the user interface element for expanding the video content in the first user interface.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing additional control options for a web browser, thereby increasing the effectiveness, efficiency, and user satisfaction with such devices. Such methods and interfaces may complement or replace conventional methods for providing control options for a web browser.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with

a touch-sensitive surface that is separate from the display in accordance with some embodiments.

FIGS. 5A-5V illustrate example user interfaces for interacting with a web browser application in accordance with some embodiments.

FIGS. 6A-6C are flow diagrams of a process displaying a page menu for a web browser that includes intelligent content in accordance with some embodiments.

FIGS. 7A-7B are flow diagrams of a process for providing a theater mode option in a web browser application in accordance with some embodiments.

### DESCRIPTION OF EMBODIMENTS

A system is provided for displaying a page menu for a web browser application that includes one or more controls for the web browser application and optionally includes intelligent content related to the content displayed in the web browser application. A system is further provided for determining whether or not video content is available in a webpage of a web browser application, and dynamically displaying an option to increase the size of the video.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

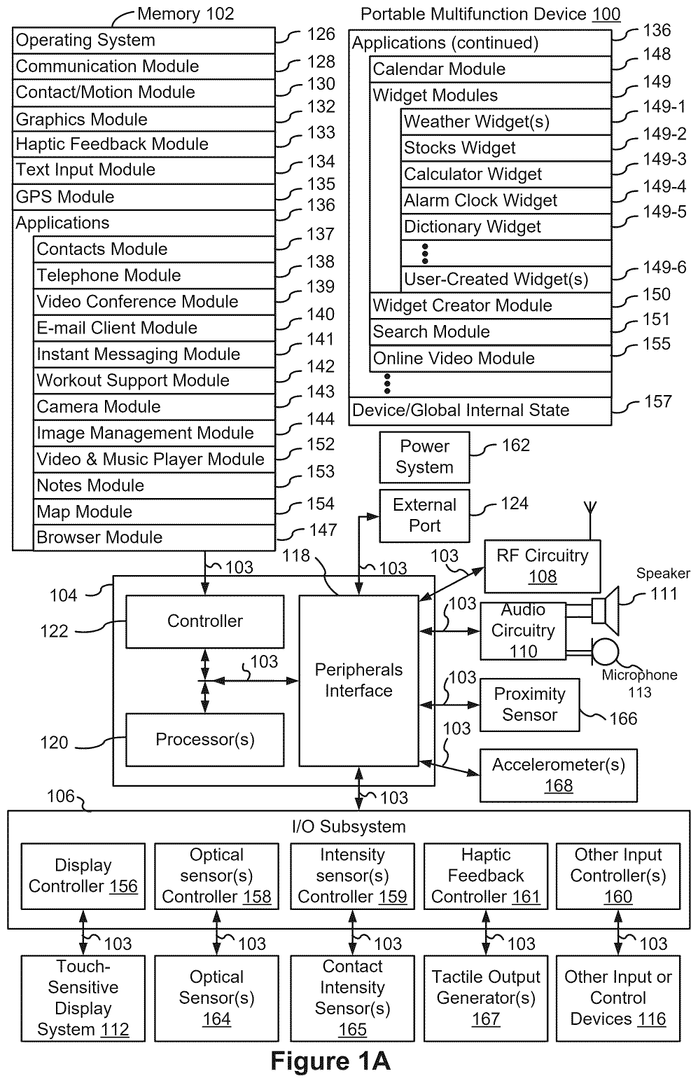

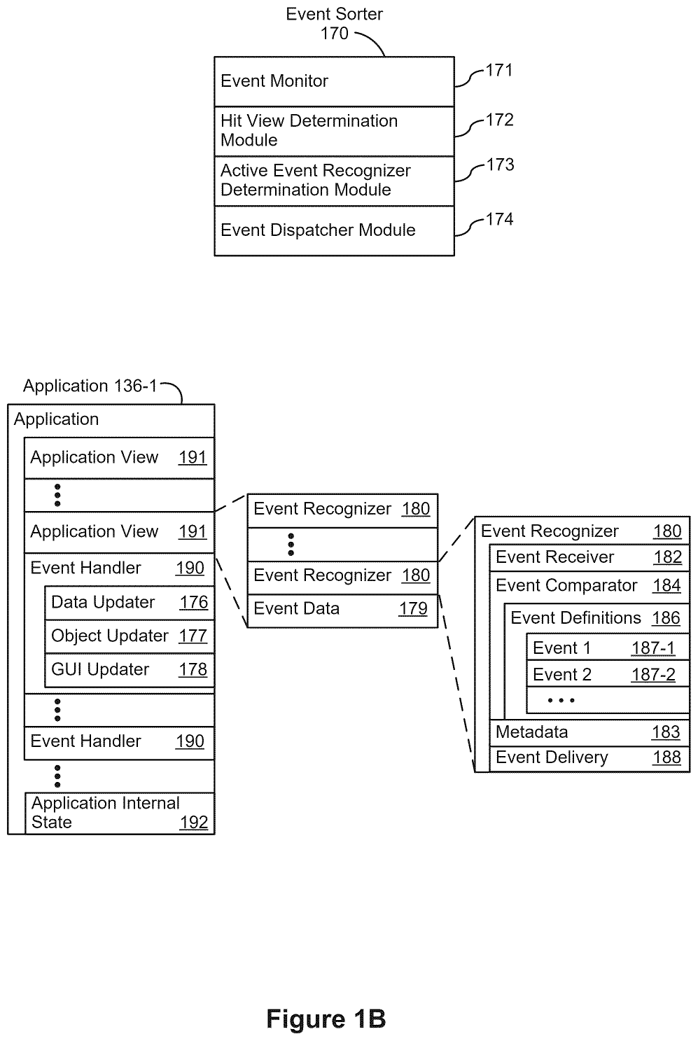

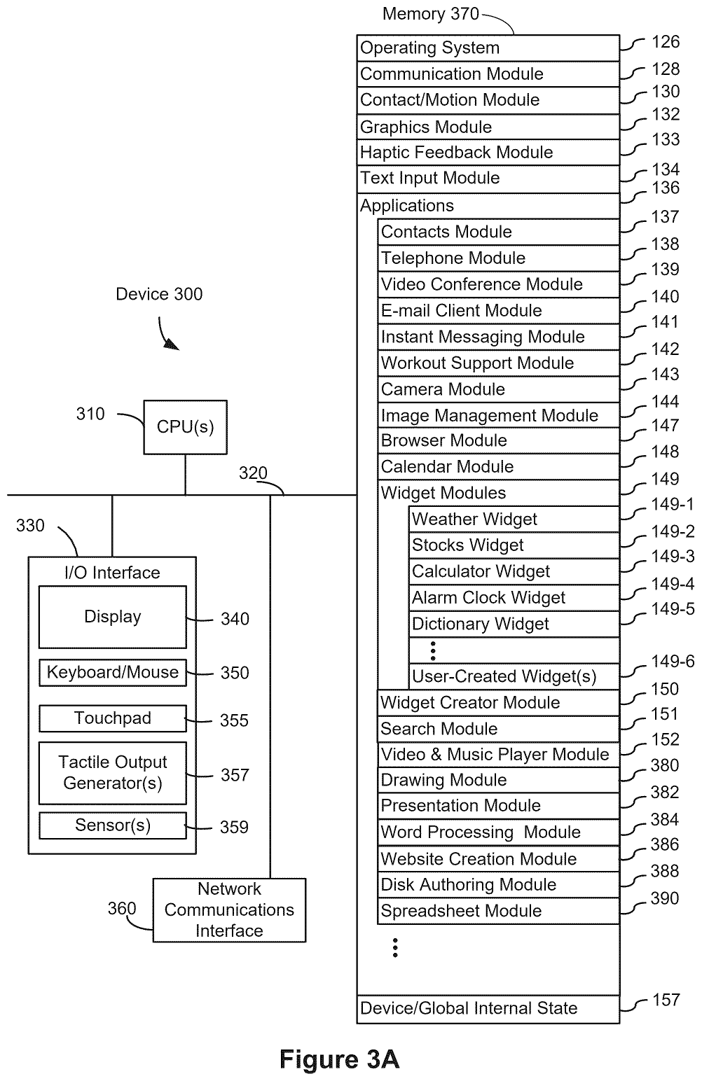

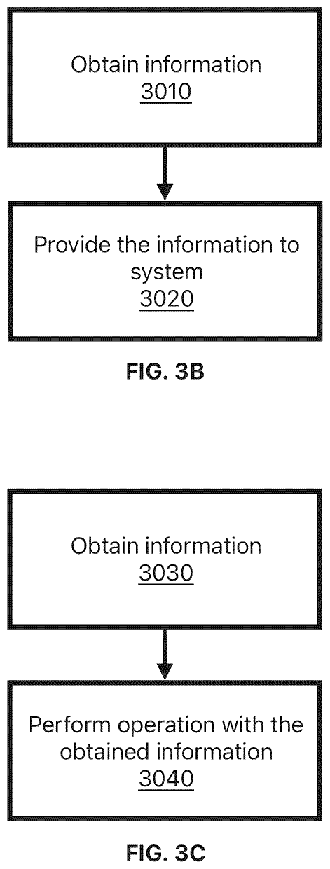

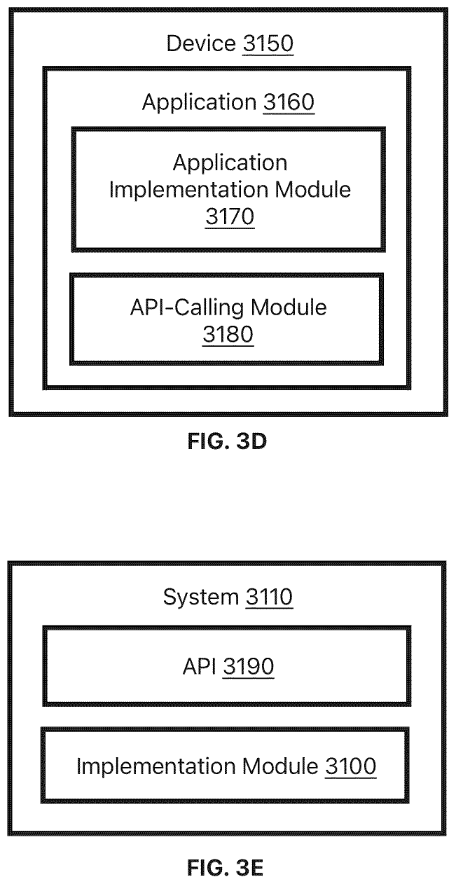

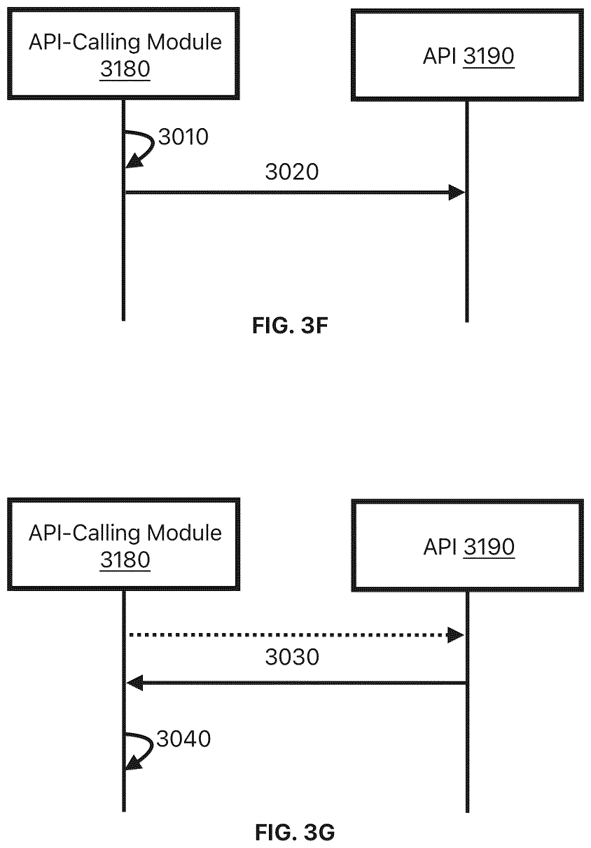

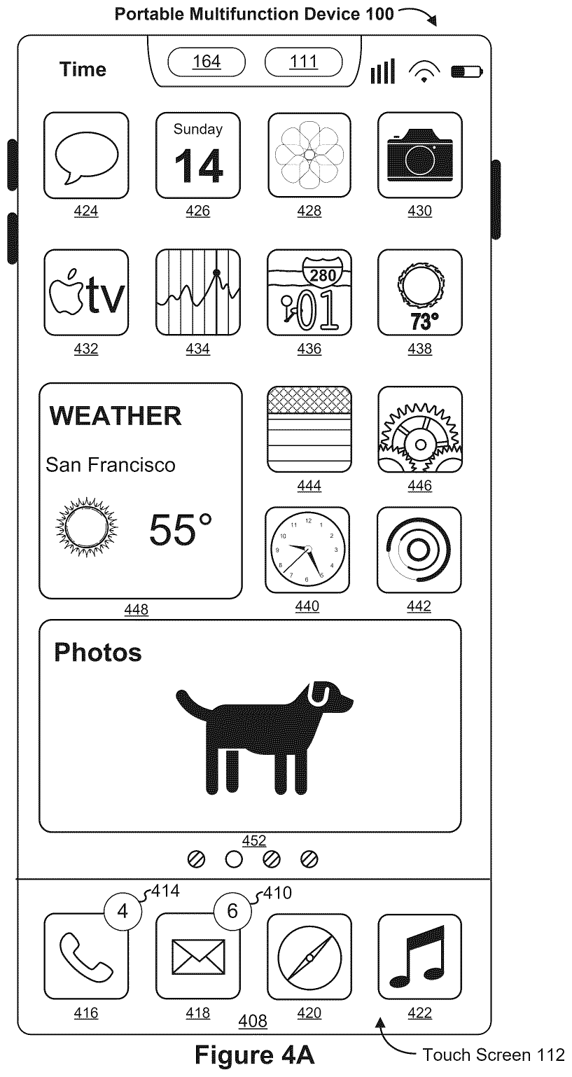

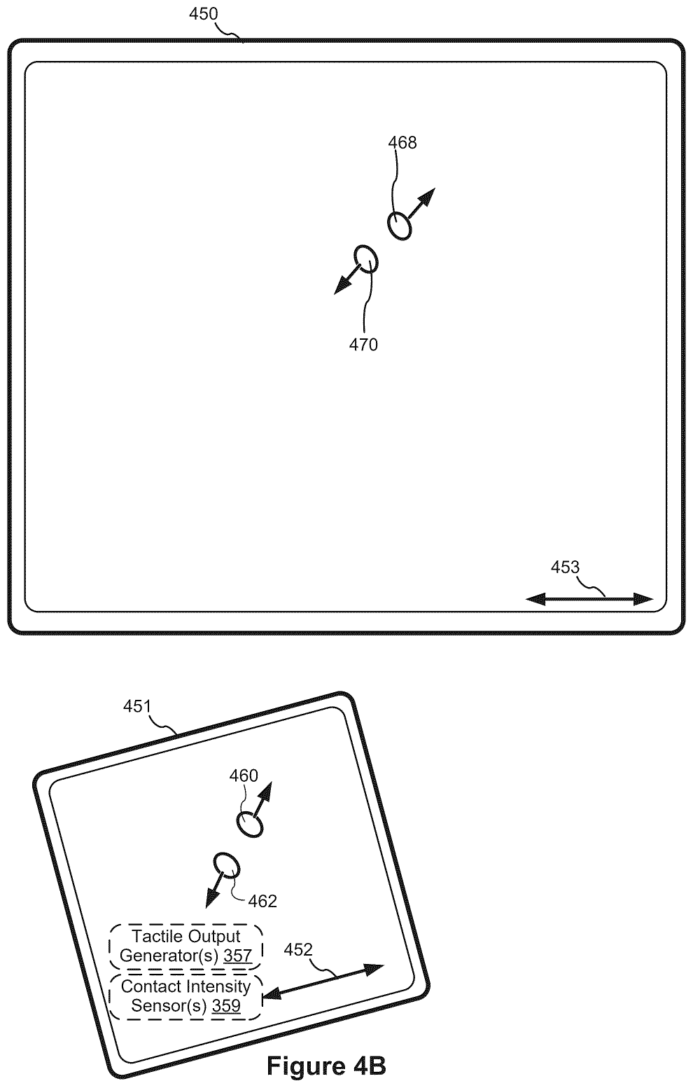

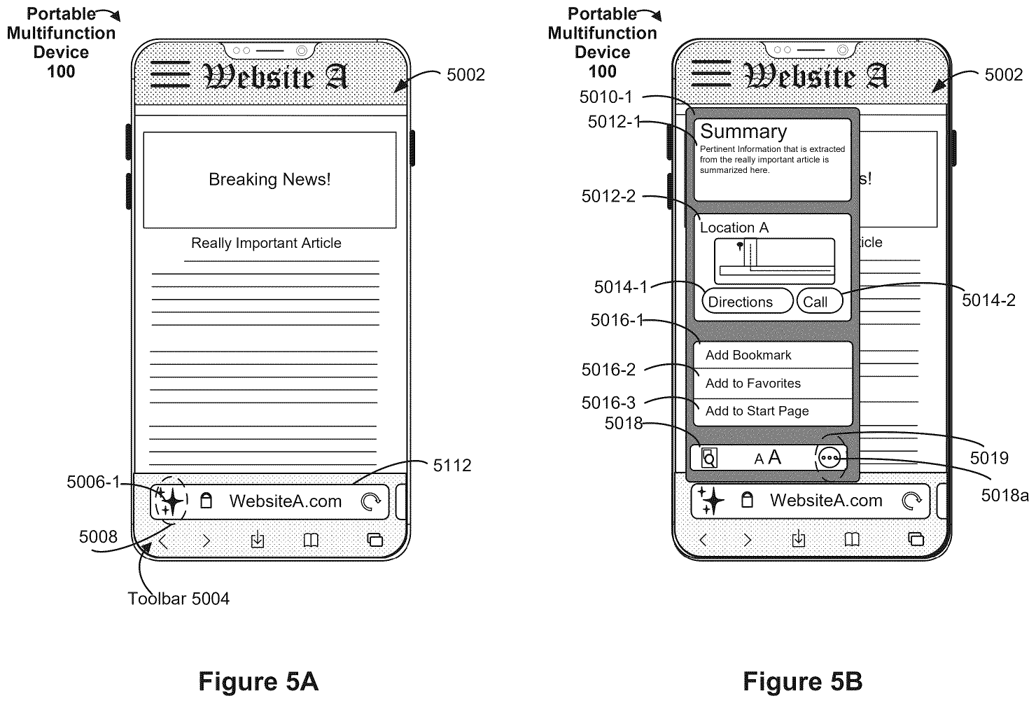

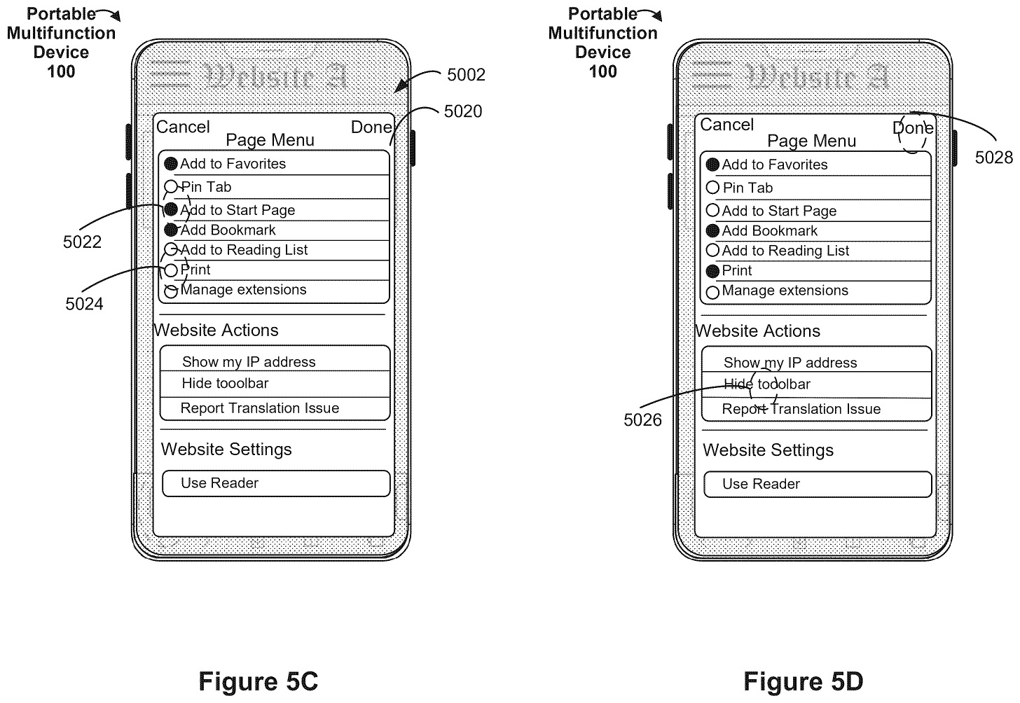

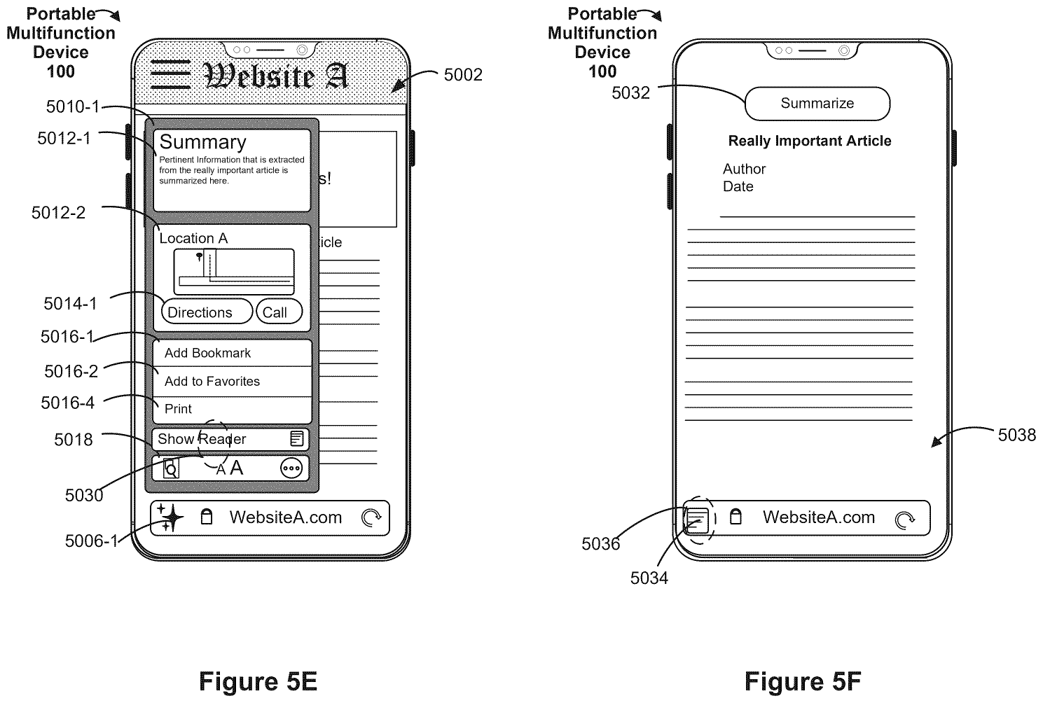

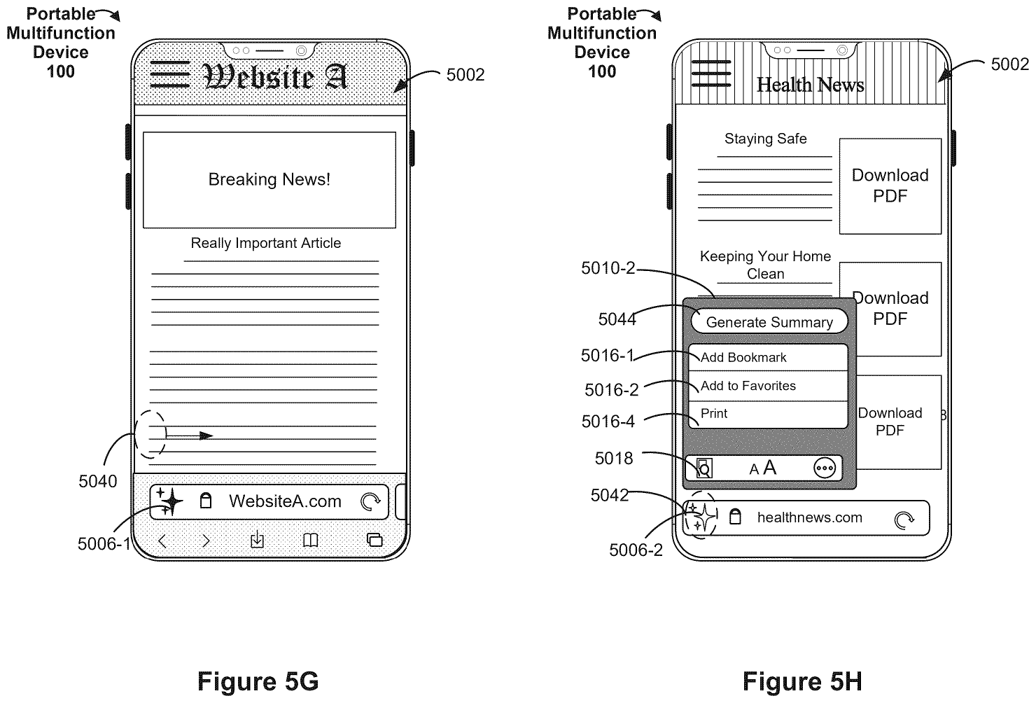

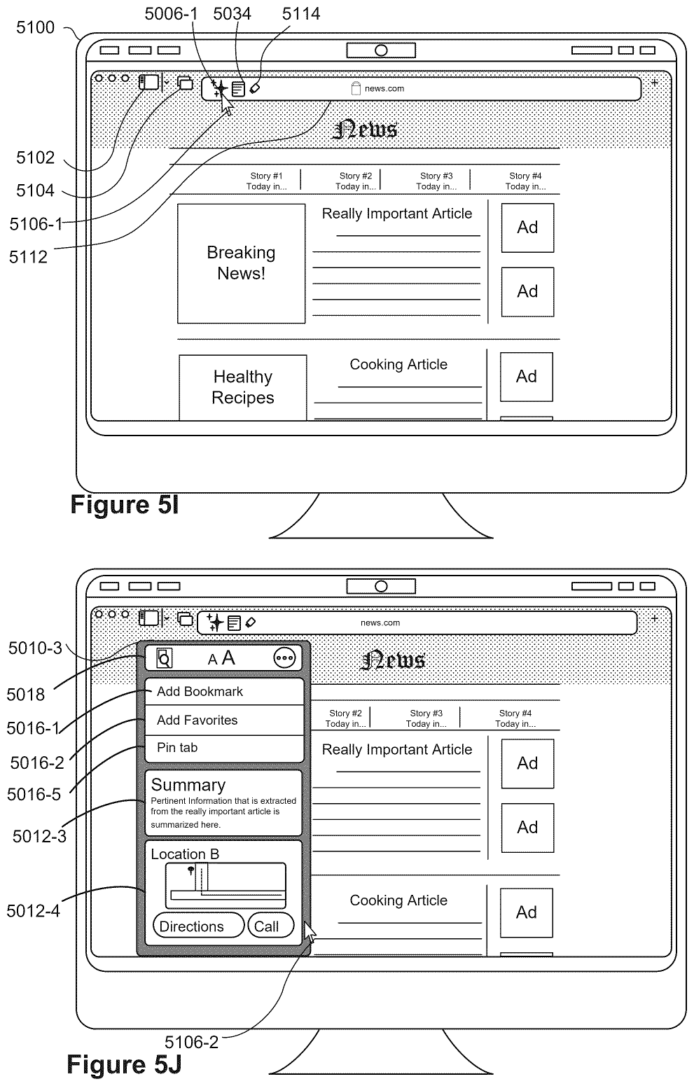

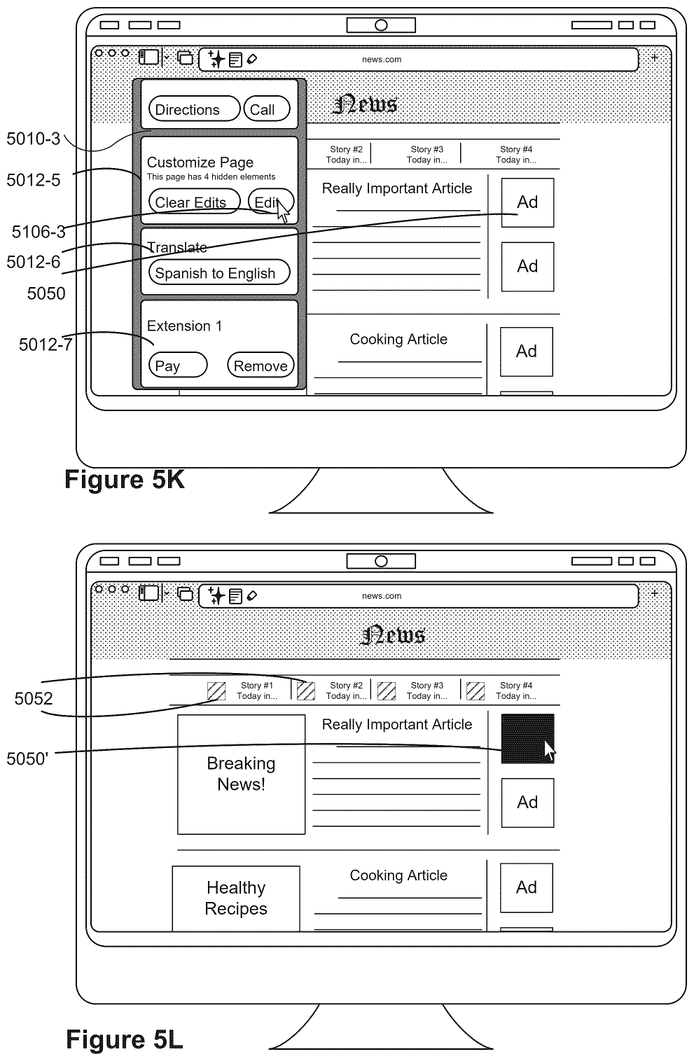

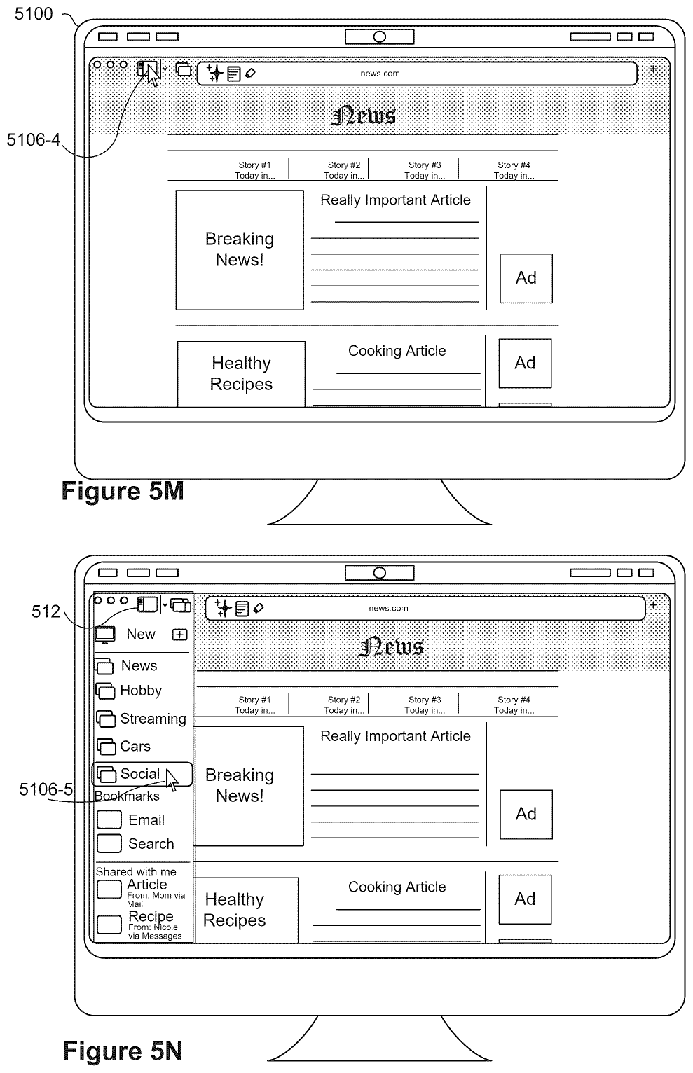

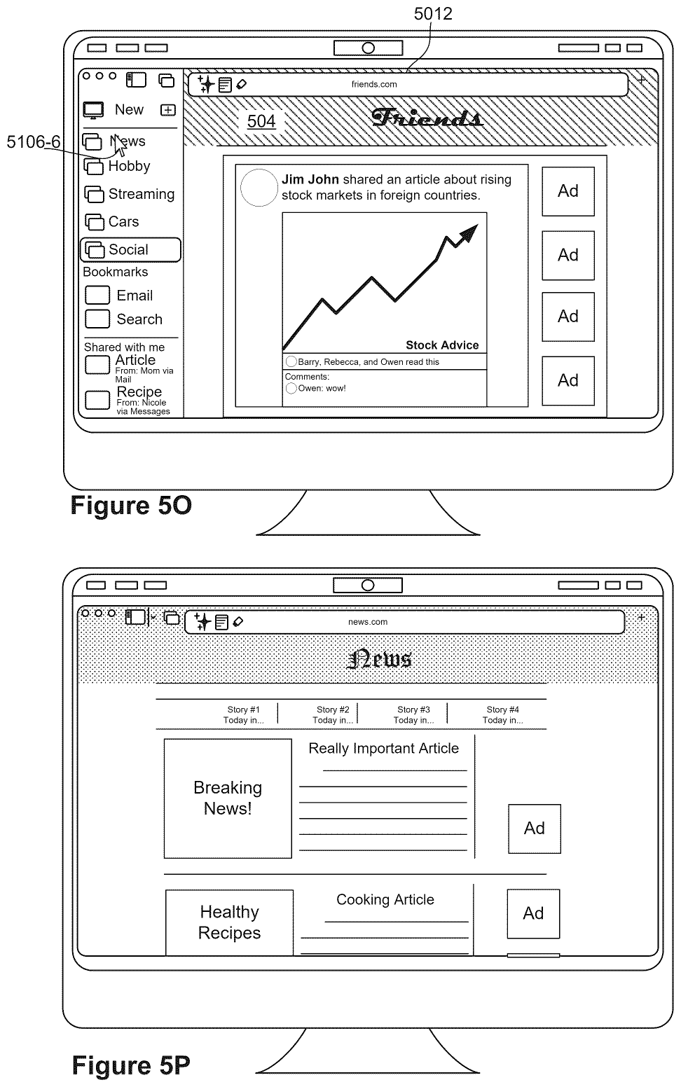

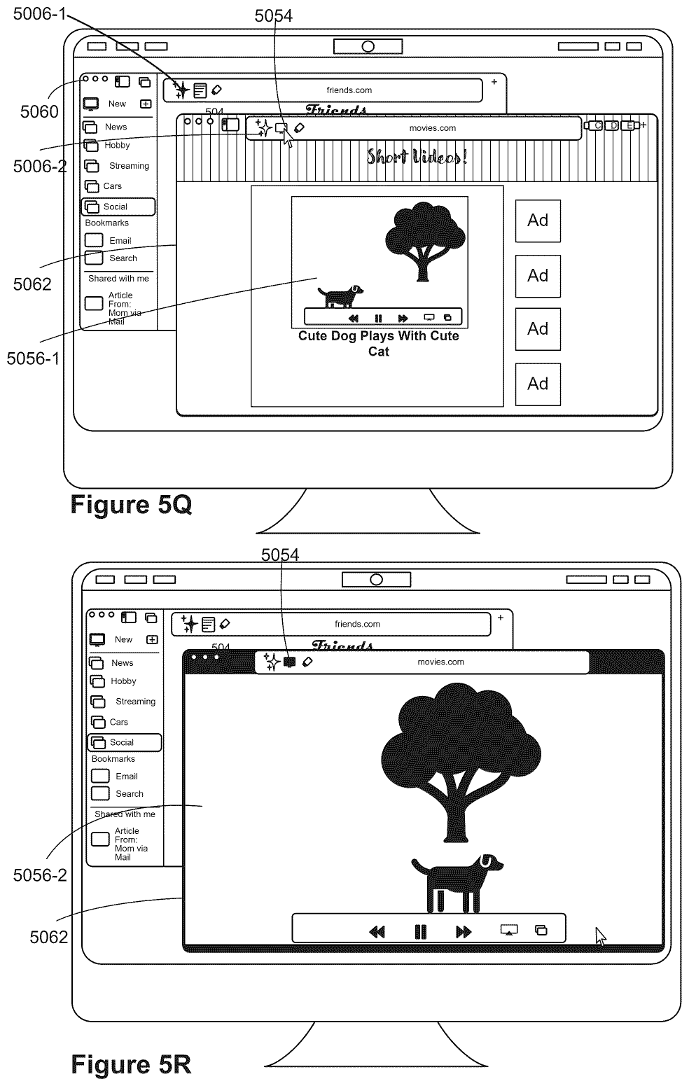

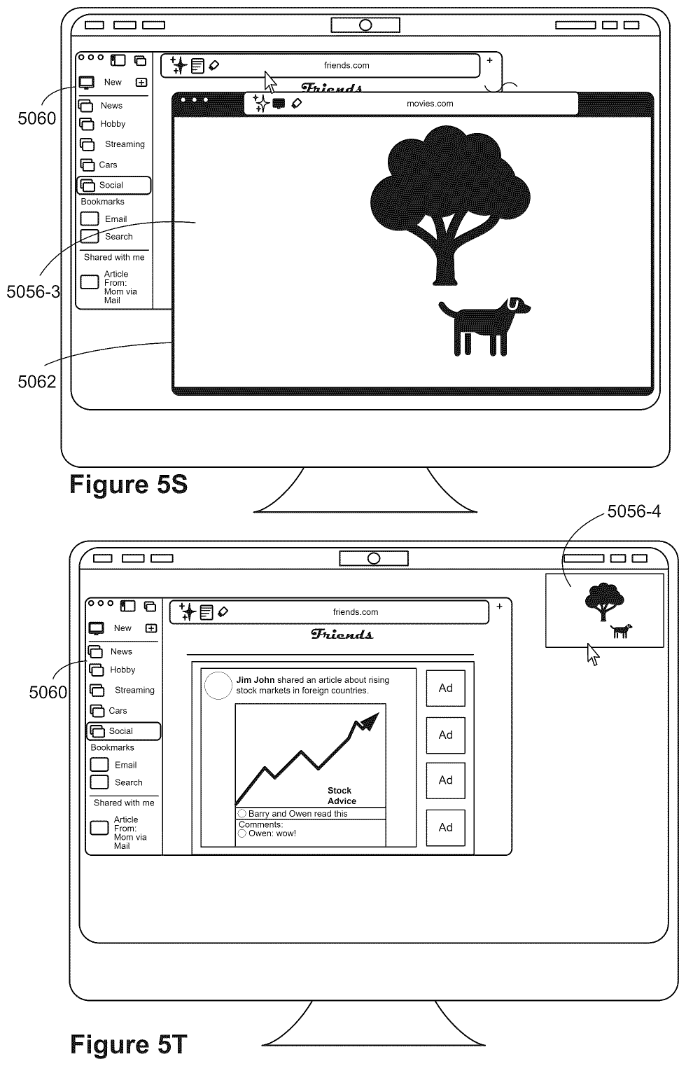

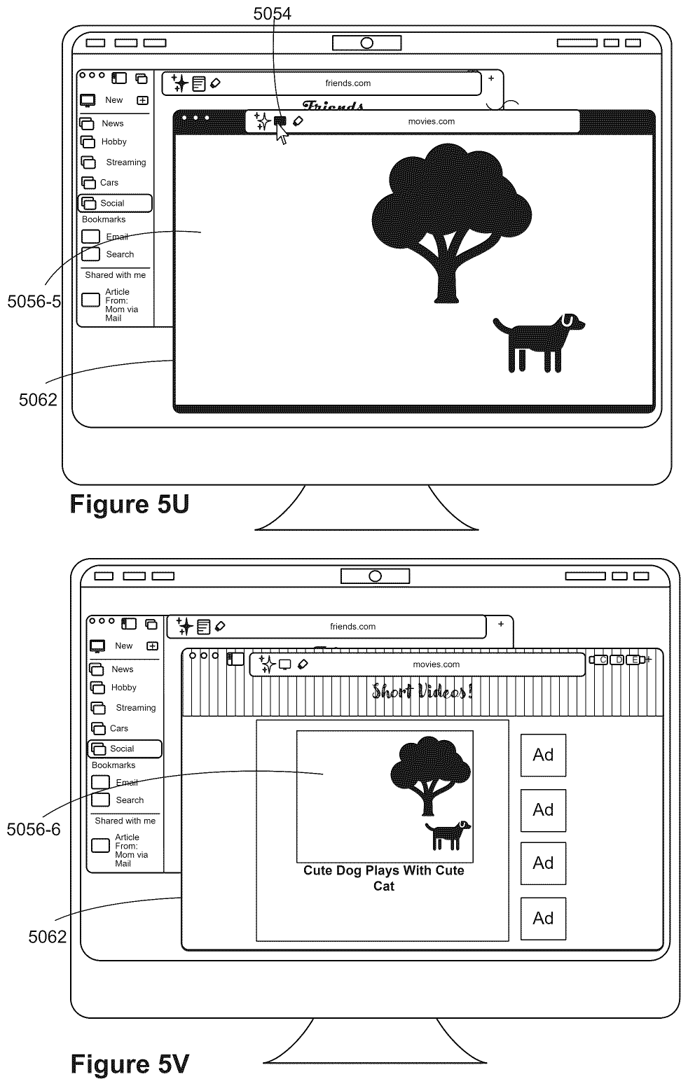

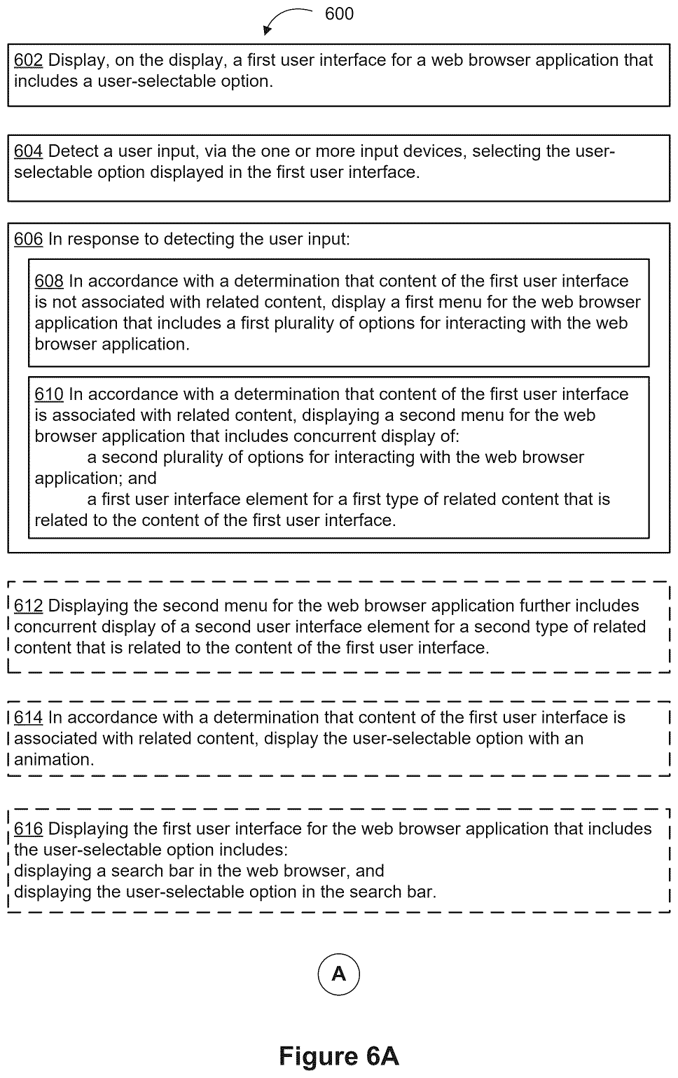

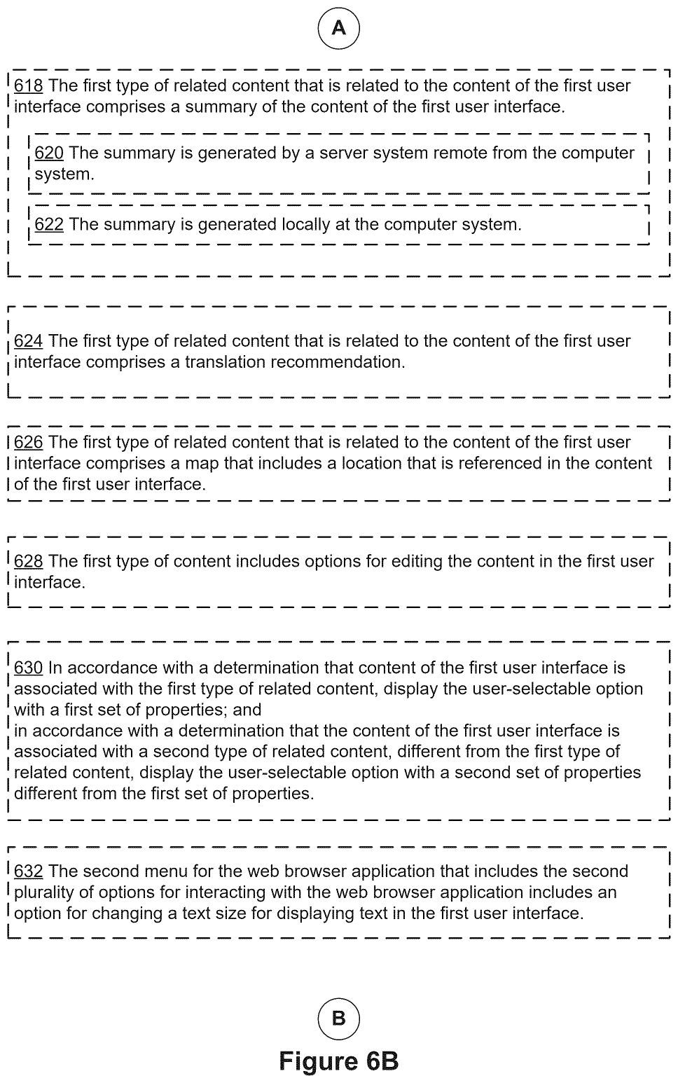

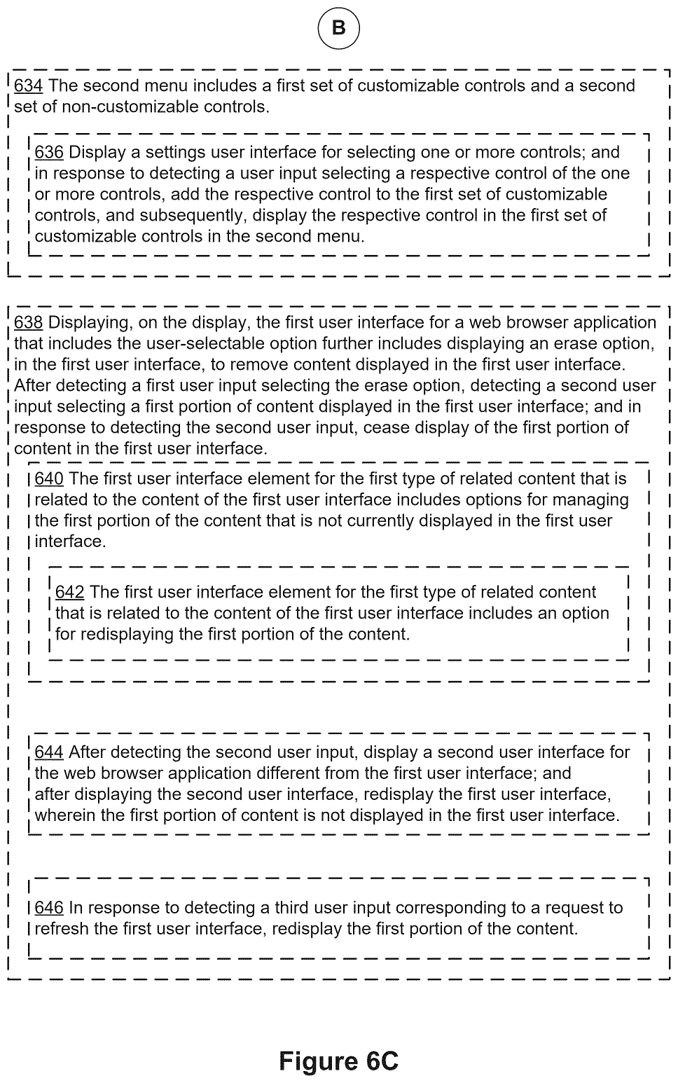

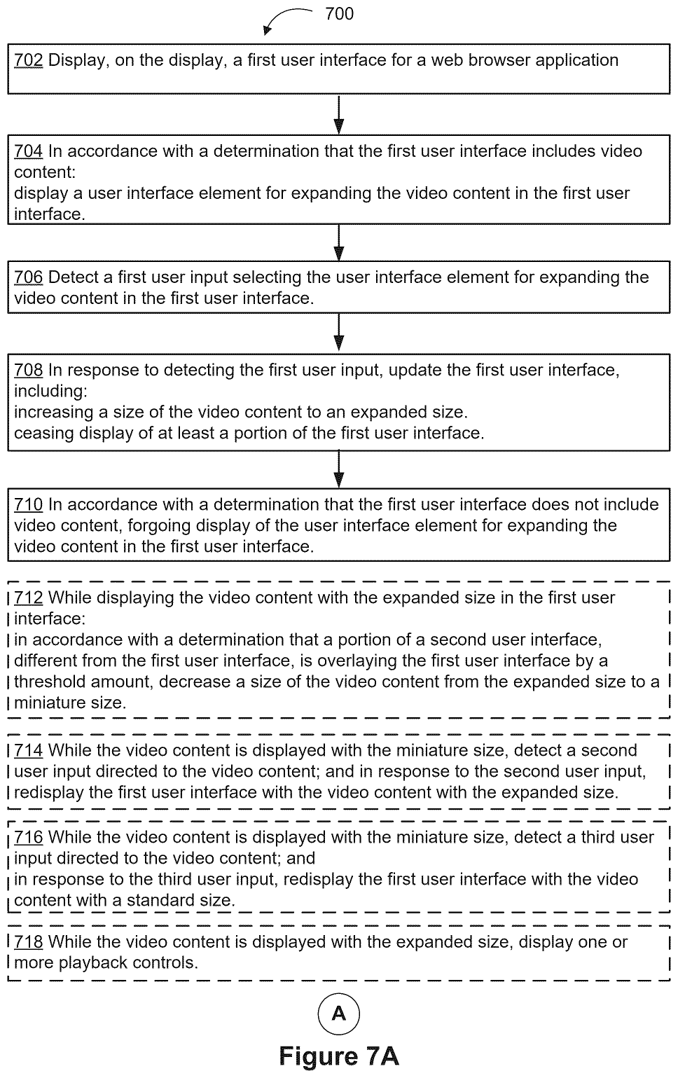

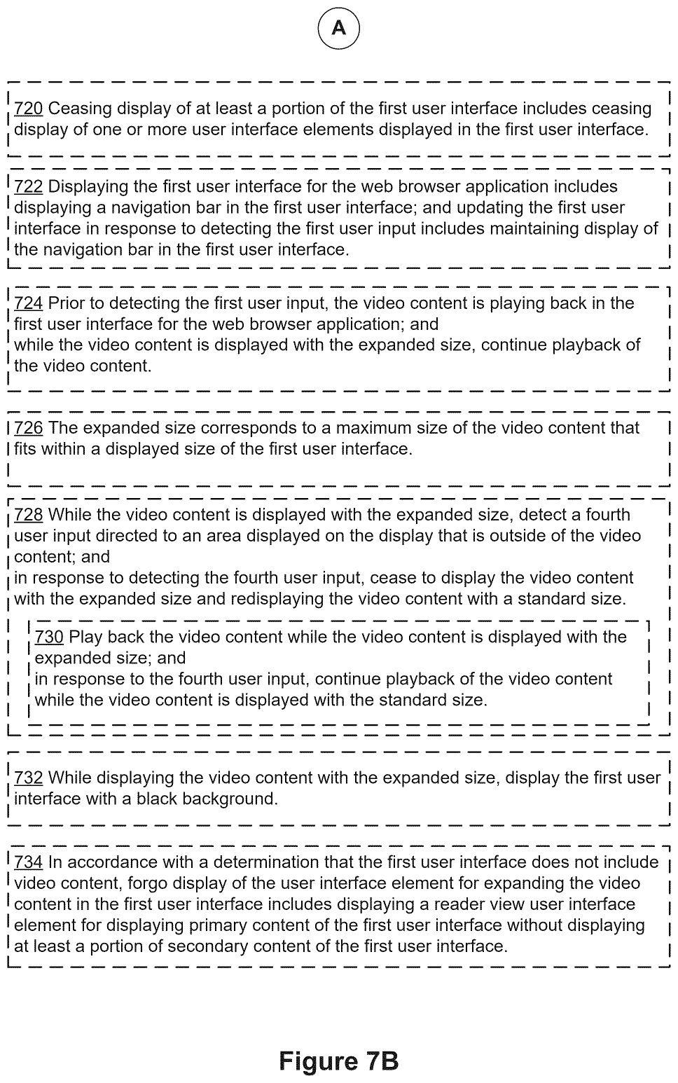

Below, FIGS. 1A-1B, 2, and 3A provide a description of example devices. FIGS. 3B-3G describe the use of Application Programming Interfaces (APIs) to perform operations. FIGS. 4A-4B and 5A-5V illustrate example user interfaces for interacting with a web browser application. FIGS. 6A-6C illustrate a flow diagram of a method of displaying a page menu for a web browser that includes intelligent content. FIGS. 7A-7C illustrate a flow diagram of a method of providing a theater mode option in a web browser application. The user interfaces in FIGS. 5A-5V are used to illustrate the processes in FIGS. 6A-6C and 7A-7B.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPU s) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA +, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

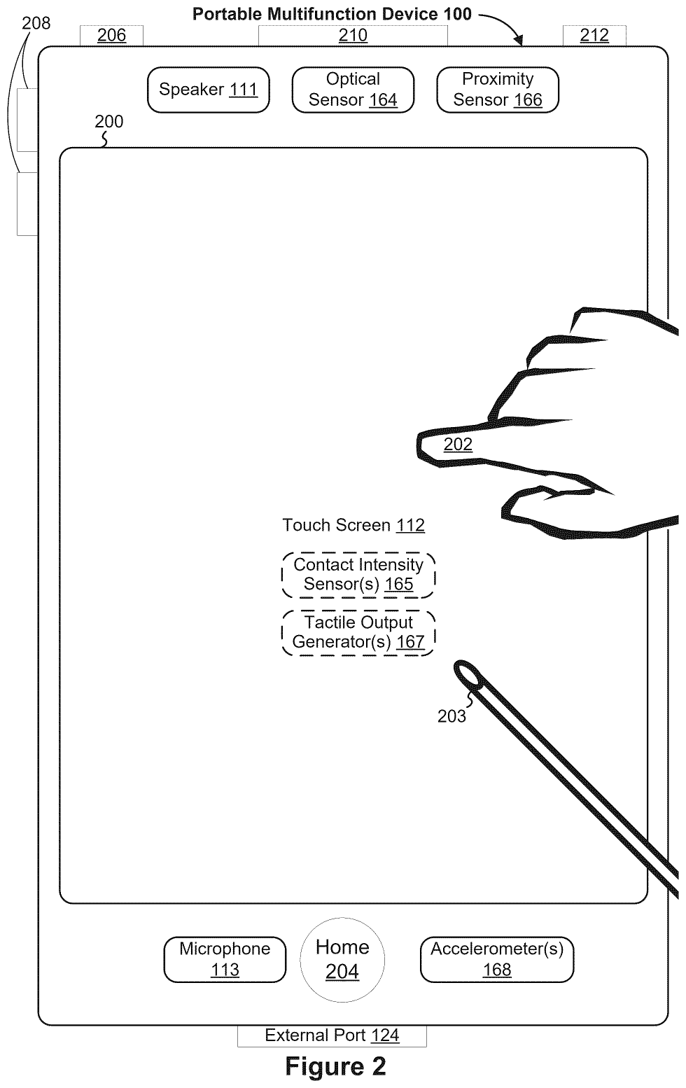

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CM OS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch” /multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met-are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or.
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIGS. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDRRAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and A PI-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with A PI-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by A PI 3190. In some embodiments, API-calling module 3180 makes an A PI call via API 3190 to access and use a feature of implementation module 3100 that is specified by API 3190. In such embodiments, implementation module 3100 can return a value via A PI 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, A PI-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebK it API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination.

While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 600 (FIGS. 6A-6C) and/or method 700 (FIGS. 7A-7B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”;
   Icon 446 for a settings application or module, which provides access to settings for device 100 and its various applications 136;
   Widget 448 for displaying information from a weather application; and
   Widget 452 for displaying information from a photos application.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while some of the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

### USER INTERFACES AND ASSOCIATED PROCESSES

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5V illustrate example user interfaces for interacting with a browser application in accordance with some embodiments. The user interfaces in these figures are used to illustrate the processes described below, including the processes in FIGS. 6A-6C and 7A-7B. Although some of the examples which follow (e.g., in FIGS. 51-5V) will be given with reference to inputs on a touch-sensitive surface 451 that is separate from the display 450, in some embodiments, the device detects inputs on a touch-screen display (where the touch-sensitive surface and the display are combined), as shown in FIG. 4A. For convenience of explanation, some of the embodiments will be discussed with reference to operations performed on a device with a touch-sensitive display system 112 (e.g., in FIGS. 5A-5H). In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector (e.g., also referred to herein as a cursor).

FIGS. 5A-5V illustrate example user interfaces for interacting with a browser application in accordance with some embodiments. FIG. 5A illustrates a user interface 5002 displayed at the device 100. In some embodiments, the user interface 5002 is or includes a webpage that is displayed in a web browser application, sometimes called a web browser. For example, the user interface 5002 includes web content, such as images, text, and/or other user interface objects provided by a web server associated with the website of the current webpage.

In some embodiments, the user interface 5002 for the web browser application includes a toolbar 5004 that includes one or more controls for the web browser application, such as navigation controls (e.g., to navigate to a previous page or a next page that is displayed in the web browser application), a share control to copy a link of the current webpage and/or to provide options to share the webpage via one or more other applications, such as a messaging application, an email application, and/or another application, a bookmarks control for accessing one or more bookmarks stored for the user of the web browser application, and/or a tab view control for viewing one or more other tabs corresponding to webpages that are also open in the web browser application.

In some embodiments, the user interface 5002 for the web browser application further includes an address bar 5112, also referred to herein as a search bar, navigation bar, or a URL bar, that displays “WebsiteA.com,” for the current website. In some embodiments, the address bar 5112 includes a refresh option for requesting to refresh the web content.

In some embodiments, the address bar 5112 includes a page menu option 5006-1. In some embodiments, the page menu option 5006-1 is optionally displayed outside of the address bar 5112 (e.g., in the toolbar 5004, next to the address bar 5112, or at another position in the user interface 5002). In some embodiments, the page menu option 5006-1, when selected, provides one or more user-selectable options related to the current webpage and/or web browser application.

For example, in accordance with a determination that intelligent content is available for the current webpage, “WebsiteA.com,” the page menu option 5006-1 is displayed with a first set of visual properties, such as an animation (e.g., to make the page menu option 5006-1 appear to sparkle, flash, glow, or otherwise animate and/or attract user attention by, e.g., visually emphasizing the page menu option 5006-1 and making the page menu option 5006-1 more apparent to the user), and/or a first color (e.g., that is optionally selected based in part on the type of intelligent content that is available).

In some embodiments, intelligent content is content that is identified (e.g., by the web browser application, an operating system of the device 100, a framework of the device 100, an application different from the web browser application that is executing on the device 100 and/or an application executing at an external server system) as related to, or relevant to, the content of the webpage that is rendered in the web browser application. In some embodiments, the intelligent content is generated locally, at the device 100 (e.g., using the web browser application, an operating system of the device 100, a framework of the device 100 and/or an application different from the web browser application that is executing on the device 100) and/or generated at an external server system and stored in association with the webpage. In some embodiments, the intelligent content is identified and generated by different applications and/or devices. In some embodiments, a same application both identifies and generates the intelligent content. For example, as described with reference to FIG. 5B, in some embodiments, one or more intelligent content items are displayed as respective user interface elements 5012 in a page menu 5010-1, in response to user activation of page menu option 5006-1. In some embodiments, each respective user interface element 5012 is displayed as an individual widget or platter, associated with a respective type of intelligent and/or related content that is relevant to the webpage currently being displayed by the web browser application.

FIG. 5A illustrates detecting a user input 5008 directed to the page menu option 5006-1. In some embodiments, in response to detecting the user input 5008, the device 100 displays the page menu 5010-1, illustrated in FIG. 5B. In some embodiments, the page menu 5010-1 includes a plurality of user interface elements 5012 (e.g., including user interface element 5012-1 and user interface element 5012-2), each user interface element 5012 corresponding to a respective type of intelligent content that is identified for the webpage. For example, the user interface element 5012-1 displays a summary of the content of the webpage for “WebsiteA.com.” In some embodiments, the summary of the content is generated by an external server system and/or is generated locally at device 100. In some embodiments, the summary of the content provides an overview of key ideas and/or concepts (e.g., that are automatically detected) of the “Really Important Article” that is displayed in the webpage. For example, the summary is generated by parsing the content (e.g., including text and/or images) included in the webpage to identify concepts, ideas, themes, subjects, and/or other related information based on the content.

In some embodiments, the intelligent content includes location content for one or more locations that are referenced in the content displayed in the webpage. For example, the user interface element 5012-2 displays a map view of “Location A.” In some embodiments, the location is determined without an address of the location being explicitly provided in the content. For example, content in a webpage includes a mention of a restaurant name, a park, and/or another type of location, and the device 100 (e.g., and/or an external server system for the web browser application) fetches information about the location mentioned in the content of the webpage. For example, the address of the location is determined and the user interface element 5012-2 provides a map with a corresponding location indication (e.g., corresponding to the determined location) on the map and/or provides an option to request directions to Location A (e.g., via button 5014-1) and/or provides contact information for Location A (e.g., to provide a call button 5014-2 to initiate a phone call to Location A). As such, in some embodiments, the user interface element 5012-2 showing the location content includes one or more user-selectable control options (e.g., directions button 5014-1, call button 5014-2, and/or other buttons) for interacting with the intelligent location content. As such, the intelligent content complements the content that is in the webpage with content that is not necessarily directly available on the webpage itself.

In some embodiments, the intelligent content is another type of related content, such as a user interface element that includes stock information related to a company that is mentioned in the webpage content. In some embodiments, the intelligent content includes a translation user interface element (e.g., as described with reference to FIG. 5K, below) and/or a payment user interface element (e.g., if the content includes items that are for sale). In some embodiments, the intelligent content includes entity information corresponding to a recognized entity (e.g., a famous person, musician, sports team, and/or other entity that is well-known). For example, details about the recognized entity (e.g., biographic details, songs, movies, upcoming game schedules, game scores, and/or other information that is relevant to the recognized entity) are provided in a user interface element. It will be understood that other types of intelligent content may be contemplated for inclusion in the page menu 5010-1.

In some embodiments, the page menu 5010-1 further includes a set of customizable controls 5016, including the control 5016-1, the control 5016-2 and the control 5016-3 (e.g., that do not correspond to intelligent content). As such, the page menu 5010-1 concurrently provides access to both intelligent content (e.g., if available) and controls for controlling one or more properties of the web browser application.

In some embodiments, the page menu 5010-1 includes a set of controls 5018, that are not customizable by the user, for the web browser application. For example, the set of controls 5018 includes a find control that, when selected, performs a find operation in the content of the webpage displayed in the web browser application. In some embodiments, the set of controls 5018 includes a text size control that, when selected, provides an option for adjusting a size of the text to be displayed in the web browser application. In some embodiments, the set of controls 5018 includes a configuration button 5018a for accessing a page menu settings page 5020, as illustrated in FIG. 5C. For example, in response to detecting a user input 5019, such as a tap input or other selection input, directed to the configuration button 5018a, the device 100 displays the page menu settings page 5020.

In some embodiments, the page menu settings page 5020 is displayed as overlaying at least a portion of the user interface 5002, and the device 100 optionally visually deemphasizes the web content displayed in the user interface 5002 (e.g., displayed behind the page menu settings page 5020).

In some embodiments, the page menu settings page 5020 includes a list of options of controls that may be added to the set of customizable controls 5016. For example, in FIG. 5C, the selected options of controls include, “Add to Favorites” (e.g., corresponding to control 5016-2), “Add to Start Page” (e.g., corresponding to control 5016-3), and “Add Bookmark” (e.g., corresponding to control 5016-1). In some embodiments, the user selects and/or deselects the options of controls to include and/or exclude the respective control corresponding to the option from the set of customizable controls 5016 included in the page menu 5010. For example, in response to detecting the user input 5022 deselecting the “Add to Start Page” option, the control 5016-3 is removed from the set of customizable controls 5016 (e.g., as illustrated in FIG. 5E). In some embodiments, in response to detecting a user input 5024 selecting the “Print” option, a control 5016-4 corresponding to the “Print” option, is added to the set of customizable controls 5016 (e.g., as illustrated in FIG. 5E). As such, the user personalizes the controls to be included and/or excluded from the set of customizable controls. It will be understood that alternative and/or additional options of controls may be provided in the page menu settings page 5020. In some embodiments, the set of customizable controls displayed in the page menu includes no controls (e.g., the user has not selected any controls to be included). In some embodiments, the set of customizable controls displayed in the page menu includes more than three controls.

In some embodiments, the page menu settings page 5020 further includes one or more user selectable controls for performing website actions, for example, to cause the web browser application to show an IP address of the device 100, hide the toolbar 5004 of the web browser application and/or to report a translation issue with the website. In some embodiments, the page menu settings page 5020 includes one or more user selectable controls for controlling website settings, for example, whether or not to display the website with a reader view, as described in more detail below with reference to FIG. 5F.

FIG. 5D illustrates detecting a user input 5026 directed to the hide toolbar control. In some embodiments, in response to detecting the user input 5026, the device 100 ceases display of the toolbar 5004 in the user interface 5002 of the web page application, as illustrated in FIG. 5E. In some embodiments, after detecting the user input 5026, the device 100 detects a user input 5028 (FIG. 5D) directed to a Done button for closing or ceasing to display the page menu settings page 5020s. In some embodiments, in response to detecting the user input 5028, the device 100 ceases display of the page menu settings page 5020 and redisplays the page menu 5010-1, as illustrated in FIG. 5E.

In some embodiments, the page menu 5010-1 includes a show reader option, as illustrated in FIG. 5E. In some embodiments, the show reader option is included in the customizable set of controls 5016 (e.g., and thus can be added and/or removed from the page menu 5010-1 by the user). In some embodiments, the show reader option is displayed and cannot be customized by the user (e.g., the user cannot remove the show reader option). In some embodiments, in response to detecting the user input 5030 directed to the show reader option, the device 100 displays the user interface 5038, as illustrated in FIG. 5F.

In some embodiments, the user interface 5038 is a reader version of the user interface 5002. For example, the user interface 5038 hides at least a portion of secondary content that is displayed in the user interface 5002 (e.g., advertisement content, optionally one or more images, and/or other secondary content), and displays primary content of the webpage with one or more reader settings (e.g., text is displayed with a respective size and/or font in the reader view and/or with a black or white background) to make the primary content easier for the user to consume, without distractions from secondary content.

In some embodiments, the reader version of the user interface 5038 optionally includes a summarize button 5032. In some embodiments, the summarize button 5032 is displayed in accordance with a determination that a summary is not available in the intelligent content for the respective web content (e.g., the summary in user interface element 5012-1 is unavailable). For example, in response to detecting a user input selecting the summarize button 5032, the device 100 locally generates a summary of the content displayed in the reader view of the webpage. In some embodiments, the locally generated summary is recognized as intelligent content during a subsequent session in the web browser application (e.g., during a subsequent session that accesses the same webpage, the summary appears in the page menu 5010-2 as intelligent content).

In some embodiments, while displaying the reader version of the user interface 5038, the page menu option 5006-1 is updated to a reader option 5034. For example, in response to detecting a user input 5036 selecting the reader option 5034, the device 100 ceases display of the reader version of the user interface 5038 and redisplays the user interface 5002 for the webpage, as illustrated in FIG. 5G.

FIG. 5G illustrates detecting a user input 5040 corresponding to a request to switch to another webpage within the web browser application. For example, the user input 5040 is a swipe input in a first direction (e.g., left-to-right or right-to-left), and in response to the user input 5040, the device 100 displays a different webpage (e.g., “healthnews.com”) corresponding to a different tab in the web browser application in the user interface 5002, as illustrated in FIG. 5H.

FIG. 5H illustrates an example of a webpage displayed in the user interface 5002 of the web browser application that does not include intelligent content. For example, in accordance with a determination that the content of the webpage does not include intelligent content, the page menu option 5006-2 is displayed with a different set of visual properties than the page menu option 5006-1 that is displayed while intelligent content is available. In some embodiments, the page menu option 5006-2 is displayed as greyed out, faded, without an animation and/or otherwise visually deemphasized, for webpages, such as the one shown in FIG. 5H, that do not include intelligent content or for which intelligent content has not been identified.

In some embodiments, in response to detecting a user input 5042 directed to the page menu option 5006-2, a page menu 5010-2 is displayed, as illustrated in FIG. 5H. In some embodiments, the page menu 5010-2 does not include user interface elements for respective types of intelligent content, as intelligent content has not been identified for the content of the webpage. In some embodiments, the page menu 5010-2 concurrently displays the set of customizable controls 5016 and the set of controls 5018. As such, the page menu 5010-2 displays at least some of the same controls that are also available in the page menu 5010-1.

In some embodiments, the page menu 5010-2 optionally includes a button 5044 to generate a summary for the content of the webpage. For example, in accordance with a determination that an intelligent summary is not available for the webpage “healthnews.com,” the device 100 displays the button 5044 for the user to request a real-time, locally-generated summary (e.g., generated by portable multifunctional device 100) of the webpage. In some embodiments, in response to selection of the button 5044, a summary is generated and displayed in the page menu 5010-2.

FIGS. 5I-5P illustrate examples of a page menu 5010-3 in a user interface displayed at a device 5100. For example, the device 5100 is communicatively coupled to one or more input devices that control a position of a cursor 5106-1 for selecting and/or interacting with user interface elements in the user interface. For example, the one or more input devices comprise a mouse, a trackpad, a stylus, a keyboard, a finger (e.g., for a touch-sensitive surface) and/or another input device.

FIG. 5I illustrates the user interface for a web browser application (e.g., optionally the same web browser application described with reference to FIGS. 5A-5H), that includes display of content for a webpage. In some embodiments, the address bar 5112 includes the page menu option 5006-1, reader option 5034 and/or an erase option 5114.

For example, the page menu 5010-3 (FIG. 5J) is accessible in response to detecting a selection input (e.g., via the cursor 5106-1) directed to the page menu option 5006-1 in FIG. 5I.

It will be understood that the page menus, sets of controls and/or operations described with reference to the device 100 FIGS. 5A-5H are also available at device 5100, as illustrated in FIGS. 5I-5K.

For example, the page menu 5010-3 includes intelligent content displayed in the user interface element 5012-3 and the user interface element 5012-4. In some embodiments, the layout of the page menu 5010-3 is optionally different from the layout of the page menu 5010-1. For example, the intelligent content is displayed below the set of controls 5018 and/or the set of customizable controls 5016 in the page menu 5010-3.

In some embodiments, as illustrated in FIG. 5K, the user scrolls through the page menu 5010-3 (e.g., that includes user interface elements 5012-3 and 5012-4 representing intelligent content) to display additional intelligent content that is available for the webpage. For example, the intelligent content includes a translation user interface element 5012-6 (e.g., for translating the content of the webpage, including a prompt (sometimes called an intelligent prompt) that automatically indicates a detected language of the content and/or a desired language in which to translate the content) and/or a webpage extension user interface element 5012-7 (e.g., for controlling one or more web extensions available in the webpage, including a control option to remove the extension) (e.g., a payment application extension for submitting one or more payments). In some embodiments, the intelligent content includes a customize page user interface element 5012-5. In some embodiments, the customize page user interface element 5012-5 is displayed in accordance with a determination that the user has previously activated the erase option 5114 for the current webpage (e.g., and/or that one or more elements of the webpage have been hidden).

For example, the erase option 5114, when selected, enables the user to select various content in the webpage to be removed, or hidden, from the webpage when the webpage is displayed or rendered by the web browser application. In some embodiments, the selected content is removed from the webpage and/or hidden from the user's view in the web browser during future browser sessions. The erase option thus allows the user to customize, for a particular webpage (e.g., without applying the customization to other webpages that display similar content and/or content related to the erased content), which content (e.g., ad slots, banners, and/or other content) is to be hidden from the user's view. Such user customization may be limited to selections explicitly made by the user, where software such as a browser assistant will not proactively predict and select content for removal. In some embodiments, the user selects locations and/or other types of defined user interface objects within a webpage to be hidden for that webpage (e.g., the selected content does not correspond to a topic, subject and/or ideas expressed by the content to be erased). As such, the user's selection of content does not target particular advertisements, advertisers, topics and/or subjects. Enabling the user to remove content from respective webpages improves the web browsing experience of the user without tracking the user's selection of content to be removed (e.g., the privacy of the user is maintained without tracking the topics, subjects and/or ideas associated with the respective content that have been erased or hidden from the user's view by the user).

In some embodiments, the user interface element 5012-5 indicates that the webpage includes hidden elements (e.g., “This page has 4 hidden elements”). In some embodiments, the user interface element 5012-5 for customizing the page includes a control to “Clear Edits”, which, when selected, redisplays content that was previously hidden on the current webpage.

In some embodiments, the user interface element 5012-5 includes a control the “Edit” the page customization. For example, selection of the “Edit” control causes the device 5100 to initiate an erase mode (e.g., that is also initiated via selection of the erase option 5114). In some embodiments, while in the erase mode, the device 5100 displays representations 5052 of the hidden images (e.g., that were previously hidden by the user in the webpage), as illustrated in FIG. 5L.

For example, as illustrated in FIG. 5L, while the device 5100 is in the erase mode, the “Ad” 5050 is highlighted while the cursor is over the “Ad” 5050, and in response to detecting a selection user input while the “Ad” 5050 is highlighted, the “Ad” 5050 is removed from the display, as illustrated in FIGS. 5M-5N. As such, the user selects individual pieces of content (e.g., text boxes, advertisements, images, banners, and/or other content items) from the webpage to be hidden, or erased, from the webpage.

In some embodiments, the “Ad” 5050 continues to not be displayed, even after the user navigates to another webpage. For example, FIGS. 5M-5N illustrate the cursor 5106-4 activating a tab browser navigation panel and selecting, via the cursor 5106-5, to navigate to a Social tab available in the navigation panel. In some embodiments, in response to a user selection (e.g., via a click input or other selection input) of the Social tab, the device 5100 displays the webpage for friends.com, as illustrated in FIG. 5O (e.g., the address bar 5112 indicates the website is friends.com). FIG. 5O further illustrates the user navigating back to the news.com website by selecting the News tab, via the cursor 5106-6. In some embodiments, after the user has navigated back to news.com, the previously hidden content (e.g., Ad 5050 and the images corresponding to representations 5052) continues to not be displayed, as illustrated in FIG. 5P. In some embodiments, content that is hidden using the erase mode is redisplayed in response to the user requesting to end the erase mode. For example, the “Ad” 5050 is redisplayed in response to user selection of the “Clear Edits” control available in the user interface element 5012-5 of the page menu 5010-3 (FIG. 5K). In some embodiments, in response to detecting two or more requests to refresh the webpage within a predefined time period (e.g., within 2 seconds, within 5 seconds, or another timer period) of each other, the hidden content is redisplayed.

FIGS. 5Q-5R illustrate a theater mode option 5054 that is automatically displayed in the address bar 5112 in accordance with a determination that a video (e.g., video 5056-1) is available in the current webpage.

For example, in FIG. 5Q, a theater mode option 5054 replaces display of the reader option 5034 in the address bar 5112. FIG. 5Q illustrates two windows, window 5060 and window 5062, of the web browser application. For example, the window 5060 displays a webpage that includes intelligent content (e.g., and thus indicator 5006-1 is displayed with the color and/or animation indicating intelligent content is available), while the window 5062 displays a webpage that does not include intelligent content (e.g., and thus indicator 5006-2 is displayed with a different color and/or without an animation, as described with reference to FIG. 5H above).

In some embodiments, in response to detecting selection of the theater mode option 5054, the device 5100 initiates a theater mode for the window 5062, including increasing a size of the video 5056-1 to the size of video 5056-2, illustrated in FIG. 5R. In some embodiments, the size of the video 5056-2 is expanded to a maximum size of the window 5062. For example, the video 5056-2 is displayed at a maximum size in which its length and/or height extends to the edge of the length and/or height of the window 5062. In some embodiments, in response to detecting selection of the theater mode option 5054, the video does not enter a full screen mode (e.g., the window 5060 continues to be displayed and the size of the window 5062 does not change).

In some embodiments, one or more playback controls continue to be available while in the theater mode. In some embodiments, the one or more playback controls cease to be displayed after a threshold amount of time has passed without detecting a user input (e.g., the cursor has not moved for at least the threshold amount of time), and the one or more playback controls are redisplayed in response to detecting a user input.

In some embodiments, while the theater mode is active, the theater mode option 5054 is updated in visual appearance to indicate that the theater mode is active, as illustrated in FIG. 5R. For example, the theater mode option 5054 is displayed with a different color, size, brightness and/or other visual properties to indicate that the theater mode is active.

In some embodiments, a background of the window 5062 of the webpage is optionally set to black and/or visually deemphasized and content that is displayed in the window 5062 is hidden. For example, the banner, title of the video and/or the advertisements displayed in the window 5062 of FIG. 5Q cease to be displayed while in the theater mode in FIG. 5R.

In some embodiments, an address bar 5112 continues to be displayed while in the theater mode. In some embodiments, the address bar 5112 is hidden (e.g., ceases to be displayed) while in the theater mode.

In some embodiments, as illustrated in FIGS. 5Q-5R, playback of the video 5056-1 optionally continues while the video is expanded to video 5056-2.

FIG. 5S illustrates the user navigating, using the cursor, to the window 5060. In some embodiments, in response to detecting a request to bring the window 5060 to the foreground (e.g., in front of the window 5062) while the window 5062 is in the theater mode, the device 5100 displays the video 5056-3 in a picture-in-picture (PIP) window on the display, as illustrated in FIG. 5T.

For example, in accordance with a determination that the window 5060 overlaps with the window 5062 by at least a threshold amount (e.g., that would make viewing of the video 5056-2 difficult), the video 5056-4 is displayed in an upper right corner of the display. In some embodiments, the user moves a position of the video 5056-4 within the user interface by dragging the video 5056-4 to a different position. In some embodiments, the user selects the video 5056-4 to exit the PIP window and redisplay the video 5056-5 in the window 5062, as illustrated in FIG. 5U.

In some embodiments, upon exiting the PIP window, the video 5056-5 continues to be displayed in the theater mode. In some embodiments, upon exiting the PIP window, the video 5056-5 is not displayed in the theater mode (e.g., the window 5062 is redisplayed with the video 5056-6 at its initial size (e.g., the same size as the video 5056-1), as illustrated in FIG. 5V).

In some embodiments, in response to detecting a user input directed to the theater mode option 5054, as illustrated in FIG. 5U, the device 5100 exits the theater mode and redisplays the video 5056-6 at its initial size, optionally while continuing playback of the video 5056-6. In some embodiments, the theater mode is automatically stopped in accordance with an end of playback of the video content. In some embodiments, a user input to an area that is outside of the video 5056-5 (e.g., optionally not directed to the theater mode option 5054) causes the device 5100 to exit the theater mode.

FIGS. 6A-6C are flow diagrams illustrating method 600 of displaying a page menu that includes intelligent content in accordance with some embodiments. Method 600 is performed at a computer system (e.g., device 300, FIG. 3A, or portable multifunction device 100, FIG. 1A, device 5100, FIG. 5I) that is in communication with and/or includes a display and one or more input devices. In some embodiments, the display is a touch-screen display and the touch-sensitive surface is on or integrated with the display. In some embodiments, the display is separate from the touch-sensitive surface. Some operations in method 600 are, optionally, combined and/or the order of some operations is, optionally, changed.

As described below, method 600 provides a page menu for a web browser application that includes one or more controls for the web browser application and optionally includes intelligent content related to the content displayed in the web browser application, thereby providing additional control options for the user. Additionally, method 600 allows the user to easily access intelligent content, which is automatically generated without requiring explicit user input, for a particular webpage without requiring the user to navigate away from the webpage, thereby reducing a number of inputs needed to perform an operation.

The computer system displays (602), on the display, a first user interface (e.g., a webpage) for a web browser application that includes a user-selectable option (e.g., a menu affordance). For example, as described with reference to FIG. 5A, the user-selectable option is a page menu option 5006-1.

The computer system detects (604), a user input, via the one or more input devices, selecting the user-selectable option displayed in the first user interface.

In response to detecting the user input (606), the computer system: in accordance with a determination that content of the first user interface is not associated with related content, displays (608) a first menu for the web browser application that includes a first plurality of options for interacting with the web browser application (e.g., the first plurality of options include a first set of standard options (e.g., set of controls 5018) (e.g., change text size, find in page, and/or other options) and a second set of customizable options (e.g., add to favorites, pin tab, add bookmark, manage extensions, and/or other options that the user selects to add to the user interface element) (e.g., customizable controls 5016) (e.g., without displaying related content (e.g., related content is not available for the first user interface)). For example, as described with reference to FIG. 5H, intelligent content (e.g., also referred to herein as related content) is not available for the website healthnews.com and the page menu 5010-2 is displayed.

In response to detecting the user input (610), the computer system: in accordance with a determination that content of the first user interface is associated with related content (e.g., content related to the webpage that is currently displayed in the web browser) displays a second menu for the web browser application that includes concurrent display of: a second plurality of options for interacting with the web browser application (e.g., set of controls 5018 or another set of controls) and a first user interface element for a first type of related content that is related to the content of the first user interface (e.g., wherein the first type of related content is intelligent content that is automatically recognized and/or determined (e.g., automatically-generated visual content and/or generative visual content)). In some embodiments, the related content is intelligent content that is automatically generated and displayed in association with the first user interface. For example, the related content is intelligently identified based on content that is included in the webpage. In some embodiments, the second plurality of options include a first set of standard options (e.g., change text size, find in page, and/or other options) and a second set of customizable options (e.g., add to favorites, pin tab, add bookmark, manage extensions, and/or other options that the user selects to add to the user interface element). In some embodiments, the second plurality of options is the same as the first plurality of options. For example, as described with reference to FIG. 5B, intelligent content is available for WebsiteA.com, and the page menu 5010-1 that is displayed includes a plurality of user interface elements 5012 that each correspond to intelligent content or related content relevant to the webpage currently being displayed by the web browser application.

In some embodiments, displaying the second menu for the web browser application further includes (612) concurrent display of a second user interface element for a second type of related content that is related to the content of the first user interface. For example, the second menu for the web browser application includes concurrent display of the second plurality of options (e.g., including the standard and customizable options), a first user interface element for a first type of related content, such as a summary of the content displayed in the webpage, and a second user interface element for a second type of related content that is different from the first type of related content, such as a map that indicates a location, and optionally directions to the location, that is referenced in the webpage. In some embodiments, each user interface element is displayed as an independent widget or platter user interface element. In some embodiments, additional user interface elements (e.g., a third user interface element, a fourth user interface element, etc.) are displayed for additional types of related content (e.g., a translation, content erase options, or other related content) that are related to the content displayed in the webpage. Displaying at least two types of intelligent content, which is automatically generated without requiring explicit user input, for a particular webpage, provides additional control options for the user without requiring the user to navigate away from the webpage, thereby reducing a number of inputs needed to perform an operation.

In some embodiments, in accordance with a determination that content of the first user interface is associated with related content, the computer system displays (614) the user-selectable option with an animation or other indicator or related content (e.g., a color, a sparkle animation, a highlighting or other visual emphasis). In some embodiments, in accordance with a determination that content of the first user interface is not associated with related content, the computer system displays the user-selectable option without the animation or other indicator of related content (e.g., as a menu option that is not visually emphasized). For example, the user-selectable option (e.g., page menu option 5006-1) is animated to provide a visual indication to the user that related content that is intelligently recognized and/or determined is available for the content displayed in the first user interface (e.g., in the webpage).

In some embodiments, displaying the first user interface for the web browser application that includes the user-selectable option includes (616): displaying a search bar (e.g., address bar 5112) in the web browser, and displaying the user-selectable option in the search bar. For example, the first user interface is a webpage that includes a search bar for entering a URL and/or search terms to conduct a search using the web browser application. In some embodiments, the user-selectable option is displayed in the search bar, for example, near the left and/or right edge of the search bar. As such, the user-selectable option is displayed as part of the user interface for the web browser rather than being displayed within the webpage rendered within the web browser. Displaying the user-selectable option in a search bar of the web browser enables the user to easily access the user-selectable option from the search bar of the web browser without requiring additional user inputs.

In some embodiments, the first type of related content that is related to the content of the first user interface comprises (618) a summary of the content of the first user interface. For example, the summary of the content of the first user interface is an automatically generated summary of text displayed in the first user interface (e.g., the summary displayed in the user interface element 5012-1, FIG. 5B). For example, for a webpage that includes an article or other text content, the summary provides a brief overview of the article and/or other text content. Automatically summarizing content of a webpage and displaying the summarized content for the user reduces the amount of time required for the user to consume the content of the webpage by providing the user with an overview of the content that is generated without requiring additional user inputs.

In some embodiments, the summary is generated (620) by a server system remote from the computer system. For example, a summary is generated (e.g., pre-generated) for a respective webpage and is available to the user in the second menu for the web browser when the user navigates to the respective webpage. Displaying summarized content of a webpage that is summarized at a remote server system reduces the computational power required by the computer system to generate the summary.

In some embodiments, the summary is generated (622) locally at the computer system. In some embodiments, the computer system generates a summary for a respective webpage, optionally if a summary generated by a server system is unavailable. In some embodiments, a user is enabled to generate their own summary (e.g., as described with reference to FIGS. 5F and 5H) for the webpage and the user-generated summary is stored locally such that, when the user returns to the webpage at a later time, the user-generated summary is available in the second menu for the web browser.

In some embodiments, the first type of related content that is related to the content of the first user interface comprises (624) a translation recommendation (e.g., as described with reference to FIG. 5K). For example, the computer system detects that the content in the webpage includes one or more languages other than a default language for the user, and the second menu includes a user interface element with a recommendation for translating the webpage (or a portion of the webpage that is not in the default language) to the default language. Providing a translation option with one or more recommended languages in which to translate provides additional control options for the user, without requiring the user to navigate away from the web browser application, thereby reducing the amount of time and number of inputs required to request a translation of a webpage.

In some embodiments, the first type of related content that is related to the content of the first user interface comprises (626) a map that includes a location that is referenced in the content of the first user interface. For example, as described with reference to FIG. 5B, Location A is provided in the user interface element 5012-2, where Location A is automatically identified from the content in the webpage of WebsiteA.com. In some embodiments, the map includes directions to a location that is related to the content in the web browser (e.g., the location is mentioned in the content), information about the location, and/or an address for the location. For example, a restaurant location is indicated in the map in accordance with a determination that the webpage is a webpage for the restaurant and/or a webpage that includes a review for or otherwise mentions the restaurant. Providing a map with a location related to the content of a webpage in the menu for the web browser application provides additional information for the user, including information from another application, such as a maps application, without requiring the user to navigate away from the web browser application, thereby reducing the amount of time and number of inputs required to access the information presented in the map.

In some embodiments, the first type of content includes (628) options for editing (e.g., erasing) content in the first user interface. For example, in some embodiments, the computer system removes (e.g., using an erase option, such as erase option 5114, FIG. 5I) at least a portion of the content displayed in the webpage in response to a user selection of the at least a portion of the content, and the first user interface element displays an option (e.g., in the user interface element 5012-5, FIG. 5K) for redisplaying the at least a portion of the content and/or for removing additional content from the webpage, as described with reference to FIGS. 5K-5M. For example, the related content includes an indication of and/or controls for content that was removed (e.g., by the user using the erase option) from display in the webpage.

In some embodiments, in accordance with a determination that content of the first user interface is associated with the first type of related content, the computer system displays (630) the user-selectable option with a first set of properties; and in accordance with a determination that the content of the first user interface is associated with a second type of related content, different from the first type of related content, the computer system displays the user-selectable option with a second set of properties different from the first set of properties. For example, the user-selectable option is displayed with a first color to indicate that a first type of related content is available (e.g., a summary or other intelligent content) and is displayed with a second color to indicate that a second type of related content is available (e.g., a map or other intelligent content). In some embodiments, the user-selectable option is displayed with a color when related content is available (e.g., page menu option 5006-1, FIG. 5A), and the user-selectable option is displayed as black, grey and/or white when related content is not available (e.g., when the first menu for the web browser is available but the second menu is unavailable) (e.g., page menu option 5006-2, FIG. 5H).

In some embodiments, the second menu for the web browser application that includes the second plurality of options for interacting with the web browser application includes (632) an option for changing a text size for displaying text in the first user interface. In some embodiments, the second plurality of options in the second menu for the web browser includes the same plurality of options as the first plurality of options in the first menu (e.g., the first menu also includes the option for changing a text size). For example, the set of controls 5018 includes a text size control that, when selected, provides an option for adjusting a size of the text to be displayed in the web browser application.

In some embodiments, the second menu (e.g., and, optionally, the first menu as well) includes (634) a first set of customizable controls and a second set of non-customizable controls. For example, the first set of customizable controls includes one or more of the following control options: add to favorites, pin tab, add to start page, add bookmark, add to reading list, print, manage extensions, and optionally one or more controls for website actions (e.g., show IP address, hide toolbar, report translation issue, etc.) and optionally one or more controls for website settings (e.g., use reader or other website settings). For example, the page menu 5010-1 includes a first set of customizable controls 5016 and a second set of non-customizable controls 5018. Enabling the user to customize one or more controls displayed in a page menu for a web browser application provides additional control options for the user and makes controls that are selected by the user more accessible by displaying the selected controls in the page menu, thereby reducing a number of inputs required to access the controls selected by the user.

In some embodiments, the computer system displays (636) a settings user interface for selecting one or more controls; and in response to detecting a user input (e.g., directed to the setting user interface) selecting a respective control of the one or more controls, the computer system adds the respective control to the first set of customizable controls, and subsequently, displays the respective control in the first set of customizable controls in the second menu (e.g., adding the respective control to the first set of customizable controls). For example, the settings user interface comprises a page menu that displays a plurality of control options and an indication of whether a respective control options is currently selected to be included in the first set of customizable controls. The user selects and/or deselects a respective control option to add and/or remove the respective control option from the second menu (e.g., and/or the first menu), as described with reference to FIGS. 5C-5D. Enabling the user to customize one or more controls displayed in a page menu for a web browser application provides additional control options for the user and makes controls more accessible by displaying the selected controls in the page menu, thereby reducing a number of inputs required to access the controls selected by the user.

In some embodiments, displaying, on the display, the first user interface for a web browser application that includes the user-selectable option further includes (638) displaying an erase option (e.g., erase option 5114), in the first user interface, to remove content (e.g., object, image, frame, button, sidebar, banner or other content element) displayed in the first user interface. In some embodiments, after detecting a first user input selecting the erase option, the computer system detects a second user input selecting a first portion of content displayed in the first user interface; and in response to detecting the second user input, ceases display of (e.g., removes from display) the first portion of content in the first user interface (e.g., while maintaining content other than the first portion of the content in the first user interface), as described with reference to FIG. 5L.

In some embodiments, the first user interface element for the first type of related content that is related to the content of the first user interface includes (640) options for managing the first portion of the content that is not currently displayed in the first user interface. For example, the first user interface element (e.g., the user interface element 5012-5) displays an option for redisplaying the first portion of the content and/or for removing additional content from the webpage.

In some embodiments, the first user interface element for the first type of related content that is related to the content of the first user interface includes (642) an option for redisplaying the first portion of the content. For example, in response to detecting a user input selecting the “Clear Edits” button displayed in FIG. 5K, the representations 5052 of the hidden images (e.g., that were previously hidden by the user in the webpage), illustrated in FIG. 5L, are redisplayed (e.g., no longer hidden) in the webpage.

In some embodiments, after detecting the second user input, the computer system displays (644) a second user interface for the web browser application (e.g., for a second webpage, different from the webpage displayed in the first user interface) different from the first user interface. For example, the user requests to navigate to a different webpage in the web browser application and in response to the user request, the web browser application displays the second user interface for a second webpage. In some embodiments, after displaying the second user interface, the computer system redisplays the first user interface, wherein the first portion of content is not displayed in the first user interface. For example, after navigating away from the first webpage, upon returning the first webpage at a later time, the erased content continues to be erased from (e.g., not displayed in) the first webpage, as described with reference to FIGS. 5N-5P.

In some embodiments, in response to detecting a third user input corresponding to a request to refresh the first user interface, the computer system redisplays (646) the first portion of the content. In some embodiments, the request to refresh the first user interface comprises two or more requests to refresh the first user interface within a threshold time period (e.g., 5 seconds, 10 seconds, or another time period). In some embodiments, a single refresh request does not cause the computer system to redisplay the first portion of the content. For example, in response to detecting the user request to refresh the first user interface, the erased content is redisplayed, as described with reference to FIG. 5P. As such, the user can easily view content that was previously erased from the webpage by refreshing the webpage.

It should be understood that the particular order in which the operations in FIGS. 6A-6C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 600 described above with respect to FIGS. 6A-6C. For example, the options, user inputs, and web browser described above with reference to method 600 optionally have one or more of the characteristics of the options, user inputs, and web browser described herein with reference to other methods described herein (e.g., method 700). For brevity, these details are not repeated here.

FIGS. 7A-7B are flow diagrams illustrating method 700 of providing a theater mode option in a web browser application in accordance with some embodiments. Method 700 is performed at a computer system (e.g., device 300, FIG. 3A, or portable multifunction device 100, FIG. 1A, device 5100, FIG. 5I) in communication with (e.g., and/or including) a display and one or more input devices. In some embodiments, the display is a touch-screen display and the touch-sensitive surface is on or integrated with the display. In some embodiments, the display is separate from the touch-sensitive surface. Some operations in method 700 are, optionally, combined and/or the order of some operations is, optionally, changed.

As described below, method 700 automatically determines whether or not video content is available in a webpage of a web browser application, and dynamically displays an option to increase the size of the video, without requiring the user to navigate complex menu hierarchies to access the settings of the web browser during video playback, thereby reducing the number of inputs needed to perform an operation and providing additional control options for the video playback experience.

The computer system displays (702), on the display, a first user interface (e.g., a webpage) for a web browser application. For example, the device 5100 displays the window 5062 for a web browser application, as described with reference to FIG. 5Q.

The computer system, in accordance with a determination that the first user interface includes video content (e.g., displayed with a standard size in the first user interface, such as video 5056-1): displays (704) a user interface element (e.g., theater mode option 5054, FIG. 5Q) for expanding the video content in the first user interface.

The computer system detects (706) a first user input selecting the user interface element for expanding the video content in the first user interface. For example, a click input via the one or more input devices while the cursor is over the theater mode option 5054.

The computer system, in response to detecting the first user input, updates (708) the first user interface, including: increasing a size of the video content to an expanded size (e.g., full screen within an application window of the first user interface); and ceasing display of at least a portion of the first user interface. For example, as described with reference to FIG. 5R, the video 5056-2 is increased in size.

The computer system, in accordance with a determination that the first user interface does not include video content, forgoes display (710) of the user interface element for expanding the video content in the first user interface. For example, in the window 5060 (e.g., that does not include video content), the theater mode option 5054 is not displayed, and optionally, the reader option 5034 is displayed.

In some embodiments, while displaying the video content with the expanded size in the first user interface (712), in accordance with a determination that a portion of a second user interface, (e.g., the second user interface is another window of the web browser application) (in some embodiments, the second user interface is an application window for an application distinct from the web browser application) different from the first user interface, is overlaying the first user interface by a threshold amount (e.g., at least 50%, at least 40%), the computer system decreases a size of the video content from the expanded size to a miniature size (e.g., a PIP window) (e.g., automatically without additional user input). For example, the computer system detects that at least a portion of a second user interface is at least partially overlaying (e.g., overlapping and/or occluding) with the first user interface. In some embodiments, the PIP window is displayed at a position that is optionally outside of the display area of the first user interface (e.g., the PIP window is displayed in an upper or lower corner of the display). In some embodiments, the user is enabled to move the PIP window to a different location by selecting and dragging the PIP window to a desired area within the display. For example, as described with reference to FIGS. 5S-5T, the video 5056-4 is displayed as a PIP window in response to the user bringing the window 5060 to the foreground of the user interface of the display. Updating display of a video content item that is visually obscured by another application window such that the video content item continues to be displayed at a smaller size, e.g., as a PIP window, enables the user to continue viewing the video content while also interacting with the other application window and reduces the number of inputs required to switch between the video content and the application window.

In some embodiments, while the video content is displayed with the miniature size (e.g., the video 5056-4), the computer system detects (714) a second user input directed to the video content (e.g., a user input corresponding to a request to view the video content); and in response to the second user input, redisplays the first user interface with the video content with the expanded size (e.g., full screen within the web browser window), as described with reference to FIGS. 5T-5U. Enabling the user to expand the video content that was displayed at a smaller size (e.g., as a PIP window) by selecting the video content, reduces the amount of time and number of user inputs to navigate to the window that includes the video content.

In some embodiments, while the video content is displayed with the miniature size, the computer system detects (716) a third user input directed to the video content (e.g., a user input corresponding to a request to view the video content); and in response to the third user input, redisplays the first user interface with the video content with a standard size. For example, as described with reference to FIGS. 5T-5U, the user selects the video 5056-4 to exit the PIP window and the computer system redisplays the video 5056-5 in the window 5062.

In some embodiments, while the video content is displayed with the expanded size, the computer system displays (718) one or more playback controls, as described with reference to FIG. 5R. In some embodiments, the one or more playback controls are displayed for a threshold time period before automatically ceasing to be displayed. In some embodiments, in response to detecting a user input, the one or more playback controls are redisplayed while the video content is displayed in the expanded size. Continuing to display playback controls for a video content item, even as a size of the video content item is changed, provides additional control options for the user.

In some embodiments, ceasing display of at least a portion of the first user interface includes (720) ceasing display of one or more user interface elements displayed in the first user interface. For example, content (e.g., banners, text, titles, recommendations, and/or other content) that is outside of the video content that is displayed in the first user interface (e.g., the webpage) ceases to be displayed, as described with reference to FIG. 5R. Hiding content in the web browser application window that is outside of the video content enables the user to view the video content without distractions outside of the video content while the video content is played back in an expanded view.

In some embodiments, displaying the first user interface for the web browser application includes (722) displaying a navigation bar (e.g., address bar 5112) in the first user interface; and updating the first user interface in response to detecting the first user input includes maintaining display of the navigation bar in the first user interface (e.g., while the video content is displayed with the expanded size). For example, as described with reference to FIG. 5R, the address bar 5112 continues to be displayed while the theater mode is active. Continuing to display the address bar of the web browser application, even while the video content is displayed in an expanded view, provides additional control options for the user to interact with the address bar.

In some embodiments, prior to detecting the first user input, the video content is playing back (724) in the first user interface for the web browser application; and, while the video content is displayed with the expanded size, the computer system continues playback of the video content. For example, playback of the video content is continuous while switching between the standard size and the expanded size (e.g., and vice-versa), as described with reference to FIG. 5R. Continuing playback of video content as the size of the video content is updated reduces the number of user inputs required to cause playback to start after the size of the video content has changed.

In some embodiments, the expanded size corresponds to (726) a maximum size of the video content that fits within a displayed size of the first user interface (e.g., the size of the first user interface does not change in response to the first user input but the video content is expanded to have a maximum width and/or height to fill the width and/or height of the first user interface), as described with reference to FIG. 5R.

In some embodiments, while the video content is displayed with the expanded size, the computer system detects (728) a fourth user input directed to an area displayed on the display that is outside of the video content; and in response to detecting the fourth user input, the computer system ceases to display the video content with the expanded size and redisplaying the video content with a standard size (e.g., optionally while continuing playback of the video content). In some embodiments, a user-selectable option is provided for exiting the expanded view and in response to detecting a user input directed to the user-selectable option, the video content is redisplayed with the standard size. For example, as described with reference to FIG. 5U, a user input is directed to the option 5054, or to another location in the display that is outside of the video 5056-5.

In some embodiments, the computer system plays back (730) the video content while the video content is displayed with the expanded size; and in response to the fourth user input, continues playback of the video content while the video content is displayed with the standard size. For example, playback is continuous while changing the display size from the expanded size to the standard size. Continuing playback of video content as the size of the video content is updated reduces the number of user inputs required to cause playback to start after the size of the video content has changed.

In some embodiments, while displaying the video content with the expanded size, the computer system displays (732) the first user interface with a black background, as illustrated in FIG. 5R. For example, content that is displayed outside of the video content in the first user interface (e.g., in the webpage) is removed and the area outside of the video content in the expanded size is black. In some embodiments, the area outside of the video content is created by a difference between a size of the application window for the web browser application and the dimensions (e.g., height vs width) of the video content.

In some embodiments, in accordance with a determination that the first user interface does not include video content, the computer system forgoes display (734) of the user interface element for expanding the video content in the first user interface includes displaying a reader view user interface element (e.g., the reader option 5034) for displaying primary content of the first user interface (e.g., main content of a webpage) without displaying at least a portion of secondary content of the first user interface (e.g., where the secondary content includes one or more of advertisements, content independent on the primary content, affordances for interacting with the primary and/or secondary content, background color(s) and/or image(s), etc. that are displayed in the webpage that are unrelated to the primary content of the webpage) (e.g., either the reader view icon or the theater mode icon is displayed based on whether or not video content is displayed in the web browser). For example, a reader mode for an article can be identified from content received (e.g. web content as a hypertext document received at a browser) to allow a user to access essential elements (e.g. hypertext elements) in the content (e.g., “primary content”), such as texts or other elements (e.g. an image, a table, etc.), relevant to the article without being distracted by elements irrelevant to the article, or non-essential elements in the content (e.g., “secondary content”). The reader mode may not be detected for content which does not contain an article, such as content for generic multimedia gallery or for multiple small comment paragraphs (e.g. a Google News web page). A preconfigured interface style independent of the article or the content may be imposed for the reader mode to present an article extracted from the content in a user appealing manner, such as via a simple scrollable text column in one font. For example, in the window 5060 (e.g., that does not include video content), the theater mode option 5054 is not displayed, and optionally, the reader option 5034 is displayed. Forgoing display of the theater mode option and instead displaying a reader view option when the web browser application does not include video content provides additional control options for the user to select the reader view option without displaying the theater mode option that is not applicable to the current webpage. Automatically determining whether or not a webpage includes video content, and either displaying a theater mode option if the webpage include video content or a reader mode option if the webpage does not include video content provides additional control options based on a context of a current webpage without requiring the user to navigate through additional options that are not relevant based on the current context.

It should be understood that the particular order in which the operations in FIGS. 7A-7B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 600) are also applicable in an analogous manner to method 700 described above with respect to FIGS. 7A-7B. For example, the options, user inputs, and web browser described above with reference to method 700 optionally have one or more of the characteristics of the options, user inputs, and web browser described herein with reference to other methods described herein (e.g., method 600). For brevity, these details are not repeated here.

The operations described above with reference to FIGS. 6A-6C and 7A-7B are, optionally, implemented by components depicted in FIGS. 1A-1B. For example, displaying operation 602, detecting operation 604, and updating operation 708 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve web browsing experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve web browsing experiences of users. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of web browsing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, intelligent content can generated by inferring preferences based on non-personal information data or a bare minimum amount of personal information, such as the content being requested by the device associated with a user, other non-personal information available to the service, or publicly available information.

What is claimed is:

1. A method comprising:
at a computer system in communication with a display and one or more input devices:
displaying, on the display, a first user interface for a web browser application that includes a user-selectable option;
detecting a user input, via the one or more input devices, selecting the user-selectable option displayed in the first user interface; and
in response to detecting the user input:
in accordance with a determination that content of the first user interface is not associated with related content, displaying a first menu for the web browser application that includes a first plurality of options for interacting with the web browser application;
in accordance with a determination that content of the first user interface is associated with related content, displaying a second menu for the web browser application that includes concurrent display of:
a second plurality of options for interacting with the web browser application; and
a first user interface element for a first type of related content that is related to the content of the first user interface.

2. The method of claim 1, wherein displaying the second menu for the web browser application further includes concurrent display of a second user interface element for a second type of related content that is related to the content of the first user interface.

3. The method of claim 1, further including, in accordance with a determination that content of the first user interface is associated with related content, displaying the user-selectable option with an animation.

4. The method of claim 1, wherein displaying the first user interface for the web browser application that includes the user-selectable option includes:
displaying a search bar in the web browser application, and
displaying the user-selectable option in the search bar.

5. The method of claim 1, wherein the first type of related content that is related to the content of the first user interface comprises a summary of the content of the first user interface.

6. The method of claim 5, wherein the summary is generated by a server system remote from the computer system.

7. The method of claim 5, wherein the summary is generated locally at the computer system.

8. The method of claim 1, wherein the first type of related content that is related to the content of the first user interface comprises a translation recommendation.

9. The method of claim 1, wherein the first type of related content that is related to the content of the first user interface comprises a map that includes a location that is referenced in the content of the first user interface.

10. The method of claim 1, wherein the first type of content includes options for editing the content in the first user interface.

11. The method of claim 1, including:
in accordance with a determination that content of the first user interface is associated with the first type of related content, displaying the user-selectable option with a first set of properties; and
in accordance with a determination that the content of the first user interface is associated with a second type of related content, different from the first type of related content, displaying the user-selectable option with a second set of properties different from the first set of properties.

12. The method of claim 1, wherein the second menu for the web browser application that includes the second plurality of options for interacting with the web browser application includes an option for changing a text size for displaying text in the first user interface.

13. The method of claim 1, wherein the second menu includes a first set of customizable controls and a second set of non-customizable controls.

14. The method of claim 13, including:
displaying a settings user interface for selecting one or more controls; and
in response to detecting a user input selecting a respective control of the one or more controls, adding the respective control to the first set of customizable controls, and subsequently, displaying the respective control in the first set of customizable controls in the second menu.

15. The method of claim 1, wherein displaying, on the display, the first user interface for a web browser application that includes the user-selectable option further includes displaying an erase option, in the first user interface, to remove content displayed in the first user interface; and
the method includes: after detecting a first user input selecting the erase option, detecting a second user input selecting a first portion of content displayed in the first user interface; and in response to detecting the second user input, ceasing display of the first portion of content in the first user interface.

16. The method of claim 15, wherein the first user interface element for the first type of related content that is related to the content of the first user interface includes options for managing the first portion of the content that is not currently displayed in the first user interface.

17. The method of claim 16, wherein the first user interface element for the first type of related content that is related to the content of the first user interface includes an option for redisplaying the first portion of the content.

18. The method of claim 15, further including:
after detecting the second user input, displaying a second user interface for the web browser application different from the first user interface; and
after displaying the second user interface, redisplaying the first user interface, wherein the first portion of content is not displayed in the first user interface.

19. The method of claim 15, further including, in response to detecting a third user input corresponding to a request to refresh the first user interface, redisplaying the first portion of the content.

20. A computer system, comprising:
a display;
one or more input devices;
one or more processors; and
memory storing one or more programs, wherein the one or more programs are configured to be executed by the one or more processors, the one or more programs including instructions for:
displaying, on the display, a first user interface for a web browser application that includes a user-selectable option;
detecting a user input, via the one or more input devices, selecting the user-selectable option displayed in the first user interface; and
in response to detecting the user input:
in accordance with a determination that content of the first user interface is not associated with related content, displaying a first menu for the web browser application that includes a first plurality of options for interacting with the web browser application;
in accordance with a determination that content of the first user interface is associated with related content, displaying a second menu for the web browser application that includes concurrent display of:
a second plurality of options for interacting with the web browser application; and
a first user interface element for a first type of related content that is related to the content of the first user interface.

21. A computer readable storage medium storing one or more programs, the one or more programs comprising instructions that, when executed by a computer system with a display and one or more input devices cause the computer system to:
display, on the display, a first user interface for a web browser application that includes a user-selectable option;
detect a user input, via the one or more input devices, selecting the user-selectable option displayed in the first user interface; and
in response to detecting the user input:
in accordance with a determination that content of the first user interface is not associated with related content, display a first menu for the web browser application that includes a first plurality of options for interacting with the web browser application;
in accordance with a determination that content of the first user interface is associated with related content, display a second menu for the web browser application that includes concurrent display of:
a second plurality of options for interacting with the web browser application; and
a first user interface element for a first type of related content that is related to the content of the first user interface.
